(19) United States
(12) Patent Application Publication
(10) Pub. No.: US 2014/0279458 A1
(43) Pub. Date: Sep. 18, 2014

(54) DEVICES, METHODS, AND SYSTEMS FOR ASSISTING MULTIPLE DISCRETE DEVICES

(71) Applicant: ELwha LLC, Bellevue, WA (US)

(72) Inventors: Pablos Holman, Seattle, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US)

(73) Assignee: ELwha LLC, Bellevue, WA (US)

(21) Appl. No.: 13/964,673

(22) Filed: Aug. 12, 2013

Related U.S. Application Data
(63) Continuation of application No. 13/964,585, filed on Aug. 12, 2013.
Application No. 13/964,585 is a continuation-in-part of application No. 13/843,118, filed on Mar. 15, 2013.
Application No. 13/843,118 is a continuation-in-part of application No. 13/907,565, filed on May 31, 2013.
Application No. 13/907,565 is a continuation-in-part of application No. 13/907,627, filed on May 31, 2013.
Application No. 13/907,627 is a continuation-in-part of application No. 13/932,914, filed on Jul. 1, 2013.
Application No. 13/932,914 is a continuation-in-part of application No. 13/932,991, filed on Jul. 1, 2013.
Application No. 13/932,991 is a continuation-in-part of application No. 13/932,918, filed on Jul. 1, 2013.
Application No. 13/932,918 is a continuation-in-part of application No. 13/932,993, filed on Jul. 1, 2013.
Application No. 13/932,993 is a continuation-in-part of application No. 13/934,134, filed on Jul. 2, 2013.
Application No. 13/934,134 is a continuation-in-part of application No. 13/934,139, filed on Jul. 2, 2013.

(51) Int. Cl. G06Q 20/10

(52) U.S. Cl. CPC G06Q 20/102
USPC 705/40

(57) ABSTRACT

Computationally implemented methods and systems include acquiring a request to carry out at least one particular transaction with a set of two or more client devices configured to carry out the particular transaction, adapting at least one vendor payment channel of a vendor payment channel set for use with a first client payment channel acquired from a first device of the set of two or more client devices, to facilitate at least a portion of a particular transaction with the first device, wherein the first client payment channel is absent from the vendor payment channel set, and adapting at least one vendor payment channel of the vendor payment channel set for use with a second client payment channel acquired from a second device of the set of two or more client devices, to facilitate at least a portion of a further transaction with the second device, wherein the second client payment channel is different than the first client payment channel. In addition to the foregoing, other aspects are described in the claims, drawings, and text.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### Priority Applications

For purposes of the USPTO extra-statutory requirements, the present application constitutes a continuation-in-part of U.S. patent application Ser. No. 13/843,118, entitled METHODS AND SYSTEMS FOR IMPLEMENTING VARIOUS TRANSACTIONAL ARCHITECTURES, naming Pablos Holman, Roderick A. Hyde, Royce A. Levien, Richard T. Lord, Robert W. Lord, and Mark A. Malamud as inventors, filed 15 Mar. 2013 with attorney docket no. 0213-003-001-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/907,565, entitled METHODS AND SYSTEMS FOR AGNOSTIC PAYMENT SYSTEMS, naming Pablos Holman, Roderick A. Hyde, Royce A. Levien, Richard T. Lord, Robert W. Lord, and Mark A. Malamud as inventors, filed 31 May 2013 with attorney docket no. 0213-003-002-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/907,627, entitled METHODS AND SYSTEMS FOR AGNOSTIC PAYMENT SYSTEMS, naming Pablos Holman, Roderick A. Hyde, Royce A. Levien, Richard T. Lord, Robert W. Lord, and Mark A. Malamud as inventors, filed 31 May 2013 with attorney docket no. 0213-003-045-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,914, entitled METHODS, SYSTEMS, AND DEVICES FOR HANDLING MULTIPLE DISPARATE SYSTEMS, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-003-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,991, entitled METHODS, SYSTEMS, AND DEVICES FOR HANDLING MULTIPLE DISPARATE SYSTEMS, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-046-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,918, entitled DEVICES, METHODS, AND SYSTEMS FOR TECHNOLOGICALLY SHIFTING OPTIONS AND MODALITIES, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-004-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,993, entitled DEVICES, METHODS, AND SYSTEMS FOR TECHNOLOGICALLY SHIFTING OPTIONS AND MODALITIES, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-047-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/934,134, entitled DEVICES, METHODS, AND SYSTEMS FOR ADAPTING CHANNEL PREFERENCES FOR A CLIENT, naming Pablos Holman, Roderick A. Hyde, Royce A. Levien, Richard T. Lord, Robert W. Lord, and Mark A. Malamud as inventors, filed 2 Jul. 2013 with attorney docket no. 0213-003-005-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/934,139, entitled DEVICES, METHODS, AND SYSTEMS FOR ADAPTING CHANNEL PREFERENCES FOR A CLIENT, naming Pablos Holman, Roderick A. Hyde, Royce A. Levien, Richard T. Lord, Robert W. Lord, and Mark A. Malamud as inventors, filed 2 Jul. 2013 with attorney docket no. 0213-003-048-000000, which is currently co-pending or is an application of which a currently co-pending application is entitled to the benefit of the filing date.

### Related Applications

United States patent application No. To Be Assigned, entitled DEVICES, METHODS, AND SYSTEMS FOR ACCEPTING MULTIPLE NONUNIFORM INPUT CHANNELS, naming Pablos Holman, Roderick A. Hyde, Royce A. Levien, Richard T. Lord, Robert W. Lord, and Mark A. Malamud as inventors, filed 12 Aug. 2013 with attorney docket no. 0213-003-006-000000, is related to the present application.

United States patent application No. To Be Assigned, entitled DEVICES, METHODS, AND SYSTEMS FOR ACCEPTING MULTIPLE NONUNIFORM INPUT CHANNELS, naming Pablos Holman, Roderick A. Hyde, Royce A. Levien, Richard T. Lord, Robert W. Lord, and Mark A. Malamud as inventors, filed 12 Aug. 2013 with attorney docket no. 0213-003-049-000000, is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

This application is related to payment systems.

### SUMMARY

In one or more various aspects, a method includes but is not limited to acquiring a request to carry out at least one particular transaction with a set of two or more client devices configured to carry out the particular transaction, adapting at least one vendor payment channel of a vendor payment channel set for use with a first client payment channel acquired from a first device of the set of two or more client devices, to facilitate at least a portion of a particular transaction with the first device, wherein the first client payment channel is absent from the vendor payment channel set, and adapting at least one vendor payment channel of the vendor payment channel set for use with a second client payment channel acquired from a second device of the set of two or more client devices, to facilitate at least a portion of a further transaction with the second device, wherein the second client payment channel is different than the first client payment channel. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for acquiring a request to carry out at least one particular transaction with a set of two or more client devices configured to carry out the particular transaction, means for adapting at least one vendor payment channel of a vendor payment channel set for use with a first client payment channel acquired from a first device of the set of two or more client devices, to facilitate at least a portion of a particular transaction with the first device, wherein the first client payment channel is absent from the vendor payment channel set, and means for adapting at least one vendor payment channel of the vendor payment channel set for use with a second client payment channel acquired from a second device of the set of two or more client devices, to facilitate at least a portion of a further transaction with the second device, wherein the second client payment channel is different than the first client payment channel. In addition to the foregoing, other system aspects are described in the claims, drawings, and text forming a part of the disclosure set forth herein.

In one or more various aspects, a system includes, but is not limited to, circuitry for acquiring a request to carry out at least one particular transaction with a set of two or more client devices configured to carry out the particular transaction, circuitry for adapting at least one vendor payment channel of a vendor payment channel set for use with a first client payment channel acquired from a first device of the set of two or more client devices, to facilitate at least a portion of a particular transaction with the first device, wherein the first client payment channel is absent from the vendor payment channel set, and circuitry for adapting at least one vendor payment channel of the vendor payment channel set for use with a second client payment channel acquired from a second device of the set of two or more client devices, to facilitate at least a portion of a further transaction with the second device, wherein the second client payment channel is different than the first client payment channel. In addition to the foregoing, other system aspects are described in the claims, drawings, and text forming a part of the disclosure set forth herein.

In one or more various aspects, a computer program product, comprising a signal bearing medium, bearing one or more instructions including, but not limited to, one or more instructions for acquiring a request to carry out at least one particular transaction with a set of two or more client devices configured to carry out the particular transaction, one or more instructions for adapting at least one vendor payment channel of a vendor payment channel set for use with a first client payment channel acquired from a first device of the set of two or more client devices, to facilitate at least a portion of a particular transaction with the first device, wherein the first client payment channel is absent from the vendor payment channel set, and one or more instructions for adapting at least one vendor payment channel of the vendor payment channel set for use with a second client payment channel acquired from a second device of the set of two or more client devices, to facilitate at least a portion of a further transaction with the second device, wherein the second client payment channel is different than the first client payment channel. In addition to the foregoing, other computer program product aspects are described in the claims, drawings, and text forming a part of the disclosure set forth herein.

In one or more various aspects, a device is defined by a computational language, such that the device comprises one or more interchained physical machines ordered for acquiring a request to carry out at least one particular transaction with a set of two or more client devices configured to carry out the particular transaction, one or more interchained physical machines ordered for adapting at least one vendor payment channel of a vendor payment channel set for use with a first client payment channel acquired from a first device of the set of two or more client devices, to facilitate at least a portion of a particular transaction with the first device, wherein the first client payment channel is absent from the vendor payment channel set, and one or more interchained physical machines ordered for adapting at least one vendor payment channel of the vendor payment channel set for use with a second client payment channel acquired from a second device of the set of two or more client devices, to facilitate at least a portion of a further transaction with the second device, wherein the second client payment channel is different than the first client payment channel.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1A-1AI, shows a high-level system diagram of one or more exemplary environments in which transactions and potential transactions may be carried out, according to one or more embodiments.

FIG. 2A shows a high-level block diagram of an exemplary environment 200, according to one or more embodiments.

FIG. 2B shows a high-level block diagram of a device 280 operating in an exemplary environment 200, according to one or more embodiments.

FIG. 2C shows an exemplary implementation of a vendor device 280′ as a device 280, according to one or more embodiments.

FIG. 3, including FIGS. 3A-3C, shows a particular perspective of a request to carry out at least one particular transaction with a set of two or more client devices that have a particular property in common acquiring module 252 of processing module 250 of 280 of FIG. 2B, according to one or more embodiments.

FIG. 4, including FIGS. 4A-4H, shows a particular perspective of a vendor payment channel from vendor payment channel set adapting for use with an acquired first user payment channel associated with a first device of the set of two or more client devices in order to facilitate at least a portion of the particular transaction module 254 of processing module 250 of device 280 of FIG. 2B, according to one or more embodiments.

FIG. 5, including FIGS. 5A-5C, shows a particular perspective of an vendor payment channel from vendor payment channel set adapting for use with an acquired second client payment channel different than the first client payment channel and associated with a second device of the set of two or more client devices, in order to facilitate at least a portion of a further transaction module 256 of processing module 250 of device 280 of FIG. 2B, according to one or more embodiments.

FIG. 6 is a high-level logic flowchart of a process, e.g., operational flow 600, according to one or more embodiments.

FIG. 7A is a high-level logic flow chart of a process depicting alternate implementations of an acquiring a request operation 602, according to one or more embodiments.

FIG. 7B is a high-level logic flow chart of a process depicting alternate implementations of an acquiring a request operation 602, according to one or more embodiments.

FIG. 7C is a high-level logic flow chart of a process depicting alternate implementations of an acquiring a request operation 602, according to one or more embodiments.

FIG. 8A is a high-level logic flow chart of a process depicting alternate implementations of an adapting at least one vendor payment channel operation 604, according to one or more embodiments.

FIG. 8B is a high-level logic flow chart of a process depicting alternate implementations of an adapting at least one vendor payment channel operation 604, according to one or more embodiments.

FIG. 8C is a high-level logic flow chart of a process depicting alternate implementations of an adapting at least one vendor payment channel operation 604, according to one or more embodiments.

FIG. 8D is a high-level logic flow chart of a process depicting alternate implementations of an adapting at least one vendor payment channel operation 604, according to one or more embodiments.

FIG. 8E is a high-level logic flow chart of a process depicting alternate implementations of an adapting at least one vendor payment channel operation 604, according to one or more embodiments.

FIG. 8F is a high-level logic flow chart of a process depicting alternate implementations of an adapting at least one vendor payment channel operation 604, according to one or more embodiments.

FIG. 8G is a high-level logic flow chart of a process depicting alternate implementations of an adapting at least one vendor payment channel operation 604, according to one or more embodiments.

FIG. 8H is a high-level logic flow chart of a process depicting alternate implementations of an adapting at least one vendor payment channel operation 604, according to one or more embodiments.

FIG. 9A is a high-level logic flow chart of a process depicting alternate implementations of a payment channel adapting operation 606, according to one or more embodiments.

FIG. 9B is a high-level logic flow chart of a process depicting alternate implementations of a payment channel adapting operation 606, according to one or more embodiments.

FIG. 9C is a high-level logic flow chart of a process depicting alternate implementations of a payment channel adapting operation 606, according to one or more embodiments.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for acquiring a request to carry out at least one particular transaction with a set of two or more client devices configured to carry out the particular transaction, adapting at least one vendor payment channel of a vendor payment channel set for use with a first client payment channel acquired from a first device of the set of two or more client devices, to facilitate at least a portion of a particular transaction with the first device, wherein the first client payment channel is absent from the vendor payment channel set, and adapting at least one vendor payment channel of the vendor payment channel set for use with a second client payment channel acquired from a second device of the set of two or more client devices, to facilitate at least a portion of a further transaction with the second device, wherein the second client payment channel is different than the first client payment channel.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scalable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although user 105 is shown/described herein, e.g., in FIGS. 1, 2, and other places, as a single illustrated figure, those skilled in the art will appreciate that user 105 may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

In known systems, devices that are associated with one or more users, e.g., phones, tablets, laptops, desktops, cars, game systems, appliances, and the like, may collect data regarding the user. This data may be desired by third parties. The following describes, among other implementations, methods and systems of managing user data collected by one or more devices that may also be useful to entities that are not the user, and which entities may not necessarily have access to the data.

This application uses the words “user” and “client” interchangeably, to further underscore the intention that “user” may not necessarily be a person, but any entity that has a relationship with the vendor. The use of the word “client” does not impute any relationship between the entity and the vendor other than the potential for an exchange of goods and/or services for compensation between the client and the vendor.

Referring now to FIG. 1, FIG. 1 illustrates an exemplary system environment in which one or more methods, systems, circuitry, articles of manufacture, and computer program products and architecture, in accordance with various embodiments, may interoperate. FIG. 1 may show one or more systems that may operate in coordination or independently. One or more portions of systems in FIG. 1 may operate as a complete system, or as a component of a larger system.

Referring now to FIG. 1, FIG. 1 shows a payment initiation module 2210. The payment initiation module may be part of user device 120, or may be a separate device. Payment initiation module 120 may be any module that detects a user's intention to carry out one or more transaction. The detection of a user's intention to carry out one or more transactions may be relayed from another device, may be inferred, directly or indirectly, from user input, may be inferred from user action (e.g., a user places an item in a shopping cart, or pours a cup of coffee, or takes a bottle of wine off of a shelf), may be initiated by a person that is observing the user or otherwise interacting with the user (e.g., a barista at a coffee shop, or a technician in a mobile device store). In an embodiment, this module may be designed to provide the user with a seamless interface, e.g., the displaying of a “pay now” button, which will be described in more detail herein with respect to the “context sensitive pay button branch” observable extending to the left of payment initiation module 2210 in the context of FIG. 1. It is noted that the direction here and in other places throughout FIG. 1 was chosen merely for illustrative purposes and has no bearing or effect on the operation of the various modules and/or components of FIG. 1.

Referring again to FIG. 1, in an embodiment, payment initiation module 2210 may include payment initiation exemplary module 2210A, which is illustrated as a module that is designed to carry out an exemplary, non-limiting example embodiment, specifically, that a user desires to pay for an item that the user has selected at a store. In an example, the user has selected a bottle of wine, for which the user desires to pay. In this example, the user is in a wine store, but in another example, the store could be virtual, and the user could be in their home or at another location browsing a virtual store on a computer, tablet, mobile phone, or other device.

In an embodiment, payment initiation module 2210 may include simple payment initiation module 2210B. Simple payment initiation module 2210 may initiate a simplified payment branching module, in which a user wants to pay for an item, or determine how much an item costs, or determine whether there is enough money (e.g., cash or cash equivalents, e.g., points, rewards, rebates, coupons, tokens, etc.) in one or more accounts e.g., an item the user has taken a picture of, or placed in a cart, or grabbed, or poured, e.g., coffee in a coffee shop or soda out of a soda dispenser, and the action initiates payment, or a negotiation for payment, for the item or service. In an embodiment, a user may be wearing augmented reality glasses, and may look at an item and make some sort of hand, eye, or bodily gesture (e.g., waving the hand across the face), or speak a particular command or set of words, that indicates that the user desires to pay for an item. In an embodiment, the payment initiation may be a time based event, e.g., the start of a movie, if a user has gotten concessions from an usher or a popcorn stand, or the like, or the start of a round or an inning of a sporting event, e.g., a baseball game. In an embodiment, the details of the payment channel negotiation, either for modality, option, or both, may be hidden from the user as the completion of a transaction. In an embodiment, there may be a fixed system, e.g., a user may go to a video arcade, and receive twenty tokens worth of credits, and the simple payment initiation occurs each time the user performs an action that debits a token, until the tokens are expended.

In an embodiment, a user may be placed in an environment where the user is allowed to select multiple items, products, or services, up to a limit, which may be time, credit, money, or token-based, e.g., a buffet, or a payment for five minutes in an electronics store, or a payment that allows a user to select twenty different resistors from a bin at an electronics store, e.g., a Radio Shack. In such an embodiment, the payment initiation module may handle the negotiation of payment and alert the user when the limit has been reached.

In an embodiment, the details of how the payment is negotiated are hidden from the user. For example, the manner in which the vendor acquires payment, e.g., whether over a Wi-Fi network, or the equivalent scanning of a bar code, or the entry of a PIN number, may be obscured from the user, who may receive simplified information indicating the success or failure of the transaction, or, in an embodiment, less information than that.

In an embodiment, as shown in FIG. 1, payment branching may lead to one or more portions of a user device 120 (e.g., following the red arrow “south” or “downward”). User device 120 may include, among other elements, a device memory 126. Device memory 126 may store one or more of a user payment option set and a user payment modality set.

In an embodiment, “payment” may refer to any portion of a transaction between a user and a vendor, including the selection and/or identification of an item and/or a service. As a tangible example, the scanning of a barcode on a can of peaches at a grocery store may be part of the “payment.” As another example, a barista keying in a description of a coffee order from a user into a computing device may also be part of a “payment.” Payment may also include authentication of a user to determine a user is the entity that the user is claiming to be. Payment is used merely as a convenient shorthand to refer to the entire process from start to finish of the acquisition of one or more goods and/or services by a user, and is not intended to be limited to the point of the transaction in which money and/or money equivalents change possession from the user to the vendor.

Under the terminology of this application, “payment modality” may refer to the mechanic by which payment information is exchanged between the vendor and the user. “Payment option” refers to the type of payment utilized by the user, and may refer to a type of credit card, a type of debit card, a type of electronic currency, and the like. The term “payment channel” may refer to one or both of “payment modality” and “payment option.”

Referring again to FIG. 1, FIG. 1 shows exemplary payment options 2120. Exemplary payment options 2120 are not intended to be an exhaustive list, but merely exemplary of some of the various types of payment options. For example, exemplary payment options 2120 may include one or more of credit card A 2122 (e.g., which may be a credit card that includes travel rewards, e.g., discounts on travel expenses), credit card B 2124 (e.g., which may be a card that accumulates fuel purchasing rewards, e.g., discounts on gasoline expenses), personal debit card 2126, corporate credit card 2128, PayPal account 2132, frequent shopper rewards card 2134, gift certificate 2136 (e.g., which could refer to a specific gift certificate, e.g., “ten dollar Starbucks card” that can be redeemed only at a particular vendor, or a generic gift certificate, e.g., an “American Express gift card,” that is valid and redeemable regardless of the vendor, or a combination of the two, e.g., a gift card good at any hardware store, or any store in the downtown area of a city), instant credit approval 2138, cash 2142, foreign currency 2144, and cash equivalents 2146.

Referring again to FIG. 1, FIG. 1 shows exemplary payment modalities 2320. Exemplary payment modalities 2320 are not intended to be an exhaustive list, but merely exemplary of some of the various types of payment modalities. For example, exemplary payment modalities 2320 may include one or more of virtual currency (e.g., BitCoins, or Xbox points, and the like) 2366, one-dimensional (1-D) barcode scan 2358, credit card with swipe only 2322, credit card with swipe and personal identification number (PIN) entry 2324, biometric retinal scan 2338, biometric fingerprint scan 2342, two-dimensional (2-D) barcode scan 2356, color barcode scan 2362, credit card with swipe and signature 2325, device tap, e.g., near field communication technology 2332, audio speech recognition (e.g., identifying the words that are spoken) 2344, audio voice recognition (e.g., identifying the speaker that has spoken, e.g., voiceprint analysis, or other voice identification techniques) 2346, PIN and/or password only 2352, trusted device voucher 2354, device authentication over a wireless network 2334, device authentication over a cellular network 2336, credit card proximity (e.g., via Radio-Frequency Identification (RFID)) 2326, credit card microchip 2364, electronic funds transfer 2368, device proxy 2348 (e.g., where another, more complex device performs one or more steps in completing the payment process), and three-dimensional object identification 2372.

As shown in FIG. 1, exemplary payment options 2120 and exemplary payment modalities 2320 are illustrated as “clouds” in the drawings. This is to indicate that the payment options and the payment modalities can be substituted anywhere in the system without substantially changing the system. Specific examples may be given with specific payment options and payment modalities, but substitution with other options and/or modalities, whether listed as exemplary in this application or not listed, will not substantially change the operation of this architecture and should be considered as within the scope of this invention.

Referring again to FIG. 1, user device 120 may include user payment channel obtaining module 2240. User payment channel obtaining module obtains the various user payment channels through one or more techniques, whether retrieving from device memory, scanning the device, polling different portions of the device, receiving and/or retrieving data from a remote location, or a combination of these. Payment channel obtaining module 2240 also may be dynamic, e.g., may determine that Wi-Fi is not available as a payment modality if there is no available open wireless network. Similarly, a user may disable various modalities, e.g., a user may want to stop using Credit Card A at a particular time, for example, if the user is approaching a credit limit. Payment channel obtaining module 2240 may include one or more of user payment option set obtaining module 2220 and user payment modality set obtaining module 2230. User payment option set obtaining module 2220 may be configured to obtain the payment option set for that user under a particular set of conditions, or generally. Similarly, user payment modality set obtaining module 2230 may be configured to obtain the payment modality set for that user under a particular set of conditions, or generally.

In an embodiment, user payment option set obtaining module 2220 may include user payment option set receiving module 2222. User payment option set receiving module 2222 may receive a user payment option set from a location. In an embodiment, the user payment option set, e.g., an exemplary user payment option set 3010A, may be received from cloud storage, e.g., network storage, e.g., user payment channel set cloud storage module 3010. User payment channel set cloud storage module 3010 may be any form of storage that is remote to user device 120, regardless of the owner of the network space, or the characteristics of the space, e.g., shared, dedicated, specific, and the like.

In an embodiment, user payment option set receiving module may receive a user payment option set, e.g., exemplary user payment option set 3020B, from a user payment channel set home/enterprise server storage module 3020. Module 3020 may be a home server, for example, or may be a related device to a device carried by a user. For example, user device 120 may be a watch, or a pair of glasses, that provides functionality to a user, whereas a payment option set is stored on a phone device carried by the user, or on a phone device carried by a related user, e.g., a user's mother, classroom teacher, boss, and the like.

In an embodiment, user payment channel obtaining module 2240 may include one or more of user payment option set receiving module 2222, user payment option set retrieving module 2224, and user payment option set generating module 2226. In an embodiment, user payment modality set obtaining module 2230 may include user payment modality set receiving module 2232, user payment modality set retrieving module 2234, and user payment modality set 2236. In an embodiment, one or more of these modules may work together to obtain one or more of the user payment option set and the user payment modality set. It is noted here that “set” may include a set of one payment option, or a set of one payment modality, or an empty set (e.g., there are no available payment options under the current conditions). It is further noted that “set” implies any structure, e.g., data structure, capable of representing, storing, manipulating, transmitting, conveying, displaying, or otherwise acting upon or for data.

In an embodiment, the user payment channel obtaining module 2240 obtains the user payment channel. Referring again to FIG. 1, as an example, the obtained user payment channel set, e.g., obtained user payment channel 2260, may include user payment option set 2262 and user payment modality set 2264. It is noted that these are merely exemplary user payment option sets and user payment modality sets, and other embodiments may include other sets of various size and content. Also, although the user payment option set 2262 and the user payment modality set 2264 are illustrated separately, this is merely for ease of understanding and illustration. In an embodiment, there may be a single set that includes part or all of a user payment option set and a user payment modality set, or multiple sets that contain one or more portions of one or more of the user payment option set and the user payment modality set.

In an embodiment, the obtained user payment channel set 2260 may include user payment option set 2262. As an example, and merely for the purposes of illustration, user payment option set 2262 may include credit card A 2122 and personal debit card 2126. In an embodiment, the obtained user payment channel set 2260 may include user payment modality set 2264. As an example, and merely for the purposes of illustration, user payment modality set 2264 may include device tap near-field communication 2332 and audio-voice 2346.

In an embodiment, user device 120 also may include vendor payment channel obtaining module 2410. Although pictured as part of user device 120, this is merely for illustrative purposes. In another embodiment, user device 120 may be external to user device 120, or may communicate over any form of network or any other form of communication. Moreover, vendor payment channel obtaining module 2410 may be interpreted in the illustration as operating after user payment channel obtaining module 2240. In an embodiment, vendor payment channel obtaining module 2410 may operate after user payment channel obtaining module 2240. In other embodiments, vendor payment channel obtaining module 2410 may operate concurrently or before, or on a different thread, processor, device, or system, as user payment channel obtaining module 2240.

In an embodiment, vendor payment channel obtaining module 2410 may include a vendor interface module 2412. Vendor interface module 2412 may be configured to receive a transmission of one or more vendor payment options and/or one or more vendor payment modalities. For example, in an embodiment, vendor interface module 2412 receives a broadcast from vendor device 6100, e.g., vendor payment channel set broadcasting module 2612. In an embodiment, obtained vendor payment channel sets 2460 may include vendor payment option set 2462 and vendor payment modality set 2464.

In an embodiment, vendor payment channel obtaining module 2410 may include vendor interface retrieving module 2414. Vendor interface retrieving module 2414 may retrieve one or more portions of one or more of the vendor payment option set, e.g., vendor payment option set 2462, and vendor payment modality set 2464. In an embodiment, vendor interface retrieving module 2414 may include vendor interface retrieving from vendor module 2416 and vendor interface retrieving from trusted device module 2418. In an embodiment, vendor payment channel obtaining module 2410 may include one or more of vendor payment channel determining module 2422 and vendor payment channel detecting module 2424.

In an embodiment, vendor payment channel obtaining module 2410 may include vendor scanning module 2430. In an embodiment, vendor scanning module 2430 may be configured to use one or more tools, e.g., hardware, software, or a combination thereof, to scan the surroundings of the user device 120, or to scan related networks for information about the surroundings of user device 120, in order to obtain information about one or more vendor payment channel sets. For example, vendor scanning module may acquire information through various forms, as indicated in module 2430A. For example, the user device may acquire data about vendor payment channels from one or more trusted devices, one or more devices in the proximity that are sharing or willing to share data, through Internet network resources (e.g., social networks, e.g., Twitter, Facebook, and the like), through one or more specific databases that may be proprietary and may be provided by one or more manufacturers of devices and/or device operating systems, e.g., Apple, Inc.

In an embodiment, module 2430 may include one or more databases which may be read by vendor scanning module 2430. With respect to module 2430, the “database” may be replaced with any data structure, or may represent data that is scattered across one or more networks and collected by one or more services, which may or may not be acting under the direction of user device 120. For example, module 2430 may include vendor information proprietary database 2431A, vendor information from search engine/data repository 2431B, vendor information from polling/querying area devices 2431C, vendor information from polling/querying trusted devices 2431D, and vendor information from publicly available data 2431E. In an embodiment, one or more of these or other sources may be used to obtain a vendor payment option set and/or a vendor payment modality set.

In an embodiment, vendor payment channel obtaining module 2410 may obtain one or more vendor payment channel sets 2460. In an embodiment, and for exemplary and/or illustrative purposes only, vendor payment channel set 2460 may include vendor payment option set 2462 and/or vendor payment modality set 2464. In an embodiment, and only for exemplary purposes, vendor payment option set 2462 may include credit card A 2122 and cash 2142. In an embodiment, and only for exemplary purposes, vendor payment modality set 2464 may include credit card swipe+PIN 2324 and credit card swipe+signature 2325. In an embodiment, this information may be gathered by vendor scanning module 2430, which, in an embodiment, may query the vendor's network to determine which modalities of payment are recognized. In an embodiment, the vendor scanning module 2430 may use false data to sample the systems of the vendor, to determine what capabilities for modalities and payment options are possessed by the vendor.

In an embodiment, when the user payment channel set and the vendor payment channel sets have been obtained, then, in an embodiment, payment option comparator module 2500 and payment modality comparator module 2700 may compare the vendor payment option set and the vendor payment channel set, respectively. In the illustrated embodiment, payment option comparator module 2500 and payment modality comparator module 2700 are shown as separate modules, however, in other embodiments, they may be the same module, or scattered across various devices, or integrated into device 120. In an embodiment, a programmable chip, e.g., a central processing unit, or a portion thereof, may act as both payment modality comparator module 2700 at time A and payment option comparator module 2500 at time B. In an embodiment, payment option comparator module 2500 and payment modality comparator module 2700 may be a part of user device 120.

Referring again to FIG. 1, payment option comparator module 2500 may receive the vendor payment option set 2504 and the user payment option set 2506. In an embodiment, payment option comparator module 2508 may compare all or a portion of vendor payment option set 2504 and the user payment option set 2506. It is noted that the sets may be traversed in any known manner or form for comparison, and it is not required that the entire set of either the vendor payment option set 2504 or the user payment option set 2506 be traversed in their entirety. In an embodiment, payment option comparator module 2508 may receive user preference input 2520 and/or vendor preference input 2522, which may suggest an order in which the payment option or options are to be ranked, categorized, selected, or otherwise preferred, relative to one another or generally. Input from these modules is optional and may vary from system to system.

In an embodiment, payment option comparator module 2508 may determine that there is an overlap between vendor payment option set 2504 and user payment option set 2506. In an embodiment, overlapping set detection module 2510 may generate a calculated overlapping set 2535. It is noted that overlapping set 2535 is not required to be the entire overlapping set 2535. For example, in an embodiment, payment option comparator module 2508 may stop as soon as payment option comparator module finds one match, and that single match becomes the calculated overlapping set 2535, regardless of whether there are additional overlapping sets.

In an embodiment, payment option comparator module 2508 may determine that there is no overlap between vendor payment option set 2504 and user payment option set 2506. In an embodiment, no overlap in set detection module 2512 may transfer control to no-overlap interfacing module 2530. In an embodiment, if no overlap is detected between the vendor payment option set 2504 and the user payment option set 2506, then the no-overlap interfacing module 2530 may branch to a payment option interfacing module 2550.

For example, for exemplary purposes, in the illustrated example, “Credit Card A” is found both in the vendor payment option set 2504 and the user payment option set 2506. Thus, in an embodiment, overlapping set detection module 2510 may be invoked, and calculated overlapping set 2535 may include the set of “Credit Card A.” In another embodiment, however, if there is no overlap, then payment option interfacing module 2550 may be invoked.

In an embodiment, payment option interfacing module 2550 may be part of user device 120. In an embodiment, payment option interfacing module 2550 may partially be a part of user device 120, and partially exterior or external to user device 120. In an embodiment, payment option interfacing module 2550 may include payment option supplier contact module 2552. In an embodiment, payment option supplier contact module 2552 may contact one or more payment option administrators to determine if the user's payment option set 2506 can be expanded to include a payment option that is part of the vendor's payment option set. For example, in an embodiment, payment option supplier contact module 2552 may contact the administrator of one or more of the vendor's payment options, to see if the administrator of the payment option (e.g., the credit card company, e.g., Visa) may grant the user access to their payment system, either temporarily, as in a one-use credit card, or permanently, e.g., the granting of a persistent credit line to the user. In an embodiment, payment option supplier contact module 2552 may contact an electronic payment supplier, e.g., PayPal, or Amazon Payments, and request a one-use username and password that the user can use to interact with the vendor system, and then the electronic payment supplier can interface with one of the user payment options to receive reimbursement for processing the transaction with the vendor's payment option.

In an embodiment, payment option interfacing module 2550 may include manufacturer store as intermediary payment option module 2554. For example, in an embodiment, the manufacturer store as intermediary payment option module 2554 may contact an administrator of an online store, e.g., the Apple store, and determine if the Apple store will act as an intermediary to charge the device using its payment systems that are in place, and then handling the payment to the vendor.

In an embodiment, payment option interfacing module 2550 may include related device as intermediary payment option module 2556. For example, in an embodiment, related device as intermediary payment option module 2556 may find a related device that will pay for the item for the user. A related device may be a device that is in the user devices' contact list, or a device that is close to the user, or a device that is on a predetermined list that was approved by the device user, or a device that shares one or more characteristics with the user, or a device for which the same entity is responsible for paying the operating costs. For example, in an embodiment, if the user device 120 that is involved in the transaction is operated by a minor, then the minor's parent's device may be a related device, and may have additional payment options that can be used to interface with the vendor, on behalf of the minor.

In an embodiment, related device as intermediary payment option 2556 may include one or more of a contact list device search module 2558, a proximity device search module 2560, and/or a same-contract device search module 2562. One or more of these modules may be used to find a related device through one or more various methods, or through other methods not detailed here (e.g., through a social network accessed by the user device).

In an embodiment, payment option interfacing module 2550 may include unrelated device as intermediary payment option module 2564, which, in an embodiment, may include contracting device search module 2566 that is configured to search for devices that will take on a contract to assist the user device. For example, a person unrelated to the user may authorize their device to act as a payment intermediary. This intermediary could be nonspecific, could be specific to a store (e.g., only assist for Kohl's), could be specific to a type of stores (e.g., only assist for grocery stores), could be context-dependent (e.g., only assist for a store the device owner is currently located in, or only authorize their device to act as payment intermediary for certain user payment option types (e.g., only assist for cash transactions. The user of the unrelated device, and the unrelated device, would then bear all or a part of the burden for negotiating reimbursement from the user device, plus whatever fee is allowed or negotiated, either by the unrelated device, by the vendor, by a third party, or by a governmental entity.

In an embodiment, payment option interfacing module may include selected payment option interface transmitting module 2568, which may be configured to transmit the selected payment option, and/or one or more details about the logistics of the payment option, to the device 120. It is noted that this transmission may be virtual or internal to the device 120, and may not include an actual “transmission,” but merely a handling of data.

In an embodiment, payment option comparator module 2500 may result in a selected payment option 2480, which, in an embodiment, and solely for exemplary purposes, may be credit card A 2122.

In an embodiment, payment modality comparator module 2700 may result in a selected payment modality 2490. Referring again to FIG. 1, in an embodiment, payment modality comparator module may include modality comparator exemplary module 2702, which may be configured to determine whether there is any overlap between the user payment modality set and the vendor payment modality set. In an example, e.g., the example shown in FIG. 1, exemplary vendor payment modality set 2704 may include credit card swipe+PIN 2324 and credit card swipe+signature 2326.

In an embodiment, payment modality comparator module 2700 may include payment modality comparator module 2708. Referring again to FIG. 1, payment modality comparator module 2700 may receive the vendor payment modality set 2704 and the user payment modality set 2706. In an embodiment, payment modality comparator module 2708 may compare all or a portion of vendor payment modality set 2704 and the user payment modality set 2706. It is noted that the sets may be traversed in any known manner or form for comparison, and it is not required that the entire set of either the vendor payment modality set 2704 or the user payment modality set 2706 be traversed in their entirety. In an embodiment, payment modality comparator module 2708 may receive user preference input 2720 and/or vendor preference input 2722, which may suggest an order in which the payment modality or modalities are to be ranked, categorized, selected, or otherwise preferred, relative to one another or generally. Input from these modules is optional and may vary from system to system.

In an embodiment, payment modality comparator module 2708 may determine that there is an overlap between vendor payment modality set 2704 and user payment modality set 2706. In an embodiment, overlapping set detection module 2710 may generate a calculated overlapping set 2735. It is noted that overlapping set 2735 is not required to be the entire overlapping set 2735. For example, in an embodiment, payment modality comparator module 2708 may stop as soon as payment modality comparator module finds one match, and that single match becomes the calculated overlapping set 2735, regardless of whether there are additional overlapping sets.

In an embodiment, payment modality comparator module 2708 may determine that there is no overlap between vendor payment modality set 2704 and user payment modality set 2706. In an embodiment, no overlap in set detection module 2712 may transfer control to no-overlap interfacing module 2730. In an embodiment, if no overlap is detected between the vendor payment modality set 2704 and the user payment modality set 2706, then the no-overlap interfacing module 2730 may branch to a payment modality interfacing module 2640.

In an embodiment, e.g., in an illustrated example as shown in FIG. 1, there may be no overlap between exemplary vendor payment modality set 2704 and exemplary user payment modality set 2706. Thus, in an embodiment, no-overlap interfacing module may interface with payment modality interfacing module 2640, which may be part of device 120, separate from device 120, or a portion of which may be a part of device 120.

In an embodiment, payment modality interfacing module 2640 may include payment modality user-device as broker module 2650. In an embodiment, payment modality user-device as broker module 2650 facilitates the interface between a user payment modality and a vendor payment modality. For example, payment modality user-device as broker module 2650 may include vendor-accepted modality selecting module 2654 that is configured to select a modality that is acceptable to the vendor and that the device can broker. For example, the vendor may require a credit card swipe and PIN number as a modality. The user may have “audio—voice” as a modality because he or she does not want to physically swipe their card at a station. Thus, the device may act as a broker between the two modalities. Vendor-accepted modality selecting module 2654 may determine that, because it has a microphone to record and convert the PIN, and access to a credit card database, the device can act as a broker between the two modalities.

For example, payment modality user-device as broker module 2650 may include modality adaptation module 2654, which may be configured to take one or more steps in facilitating “conversion” of one modality supported by the device into another. This may be transparent to the user, or may require user assistance. In an embodiment, e.g., the illustrated embodiment, in step 2654EX1, the device may request the user to use the audio—voice modality to speak a PIN number into the microphone of the device, which is recorded. In an embodiment, in step 2654EX2, the device may convert the inputted audio into a PIN number in the format accepted by the vendor. In an embodiment, in step 2654EX3, the credit card data corresponding to a magnetic strip swipe data may be retrieved from a credit card database, e.g., a database run by the credit card company.

In an embodiment, payment modality user-device as broker module 2650 may include converted modality interfacing module 2656, which acts to transmit the converted swipe data and the PIN to the vendor, which treats the transaction as if the user had swiped his or her card and entered his or her PIN data.

In an embodiment, payment modality interfacing module 2640 may include payment modality related-device as broker module 2660. In an embodiment, payment modality related-device as broker module 2660 may include vendor-accepted modality selecting module, which selects one or more of the vendor modalities (for which there is no overlap) that the device is capable of brokering with assistance from another device. In an embodiment, payment modality related-device as broker module 2660 also may include criterion-meeting related device acquiring module 2662, which may use one or more search techniques to find a related device that can assist the user device in completing the transaction. The search for a related device may be similar to that described above.

In an embodiment, criterion-meeting related device acquiring module 2662 may include one or more of contact list device search module 2662A, proximity device search module 2662B, predetermined device search module 2662C, and same-contract device search module 2662D.

In an embodiment, payment modality related-device as broker module 2660 may include related device instructing module 2664, which may be configured to instruct the related device found by module 2662 regarding how to interface the vendor modality with the user device. In an embodiment, this may include transmitting payment information to the related device so that the related device may engage the vendor modality.

In an embodiment, payment modality interfacing module 2640 may include payment modality vendor equipment as broker module 2670. In an embodiment, a vendor may provide equipment, which may be third-party produced, that allows additional modalities. For example, an internet currency provider (e.g., BitCoin) may outfit various Starbucks with devices that allow BitCoin transactions to be processed, using the device as an intermediary, without changing the Starbucks infrastructure. A user device may find these broker devices (which may not be implemented entirely in hardware) and use them to facilitate transactions, and may be invisible to the end user.

In an embodiment, payment modality vendor equipment as broker module 2670 may include vendor equipment communication module 2672. In an embodiment, payment modality vendor equipment as broker module 2670 may include vendor equipment interfacing module 2674. In an embodiment, payment modality vendor equipment as broker module 2670 may include data transmission to vendor equipment module 2676. In an embodiment, payment modality vendor equipment as broker module 2670 may include transaction monitoring module 2678.

In an embodiment, payment modality interfacing module 2640 may include payment modality unrelated device as broker module 2680. For example, a person or entity may authorize their device to act as a payment intermediary for one or more stores (and could be context-dependent, e.g., the store the person is in), where the device uses one or more modalities accepted by the vendor, and the device agrees to act as a broker, in exchange for some sort of reimbursement, from the vendor, or user, or a third party, or positive publicity (e.g., a tweet sent out from a user's twitter account that acknowledges the device owner), similarly to the unrelated device as intermediary payment option module 2564.

In an embodiment, payment modality interfacing module 2640 may include selected payment modality interface transmitting module 2568, which may transmit the selected payment modality, which in an embodiment, the transmission may be internal to the device or within the workings of a particular application or module.

In an embodiment, the selected payment modality 2490 may be paired with the selected payment option into a selected payment option and modality. The combination may not be literal; it may be as simple as setting a flag indicating that a payment option and a payment modality have been selected. In an embodiment, the combination is omitted entirely, and shown in the illustration simply for ease of understanding the illustrated system.

In an embodiment, payment executing module 4000 may be a portion of the user device 120, or separate from the user device 120. Payment executing module 4000 may include vendor contacting module configured to contact the vendor to apply the payment. In an embodiment, payment executing module 4000 may include intermediary utilization applying module 4020, which may be configured to use any intermediaries, e.g., other devices, e.g., vendor devices, other user devices, other user's devices that are either related or unrelated to the user device, and the like, to assist in the carrying out of the payment.

In an embodiment, payment executing module 4000 may include intermediate steps module 4030, which may be used, for example, to convert one modality to the other, payment transmission module 4040 which may be used to transmit the payment using the selected modality, and confirmation receipt module 4050 which may communicate with the vendor to receive confirmation that the payment has been accepted.

Referring again to FIG. 1, in an embodiment, the payment initiation module may include a persistent payment button on the device 2210C. In an embodiment, persistent payment button 2210C may represent a button that allows the user to pay, that does not change based on changing payment channels. It does not necessarily mean that the button is always present, although that may be the case in an embodiment. Persistent payment button 2210C may be a soft key or a hard key and may have a distinctive design or shape, and may be designed to be easy to access, in an embodiment. In an embodiment, persistent payment button 2210C may be a persistent payment soft button 7510. In an embodiment, the persistent payment soft button 7510 may be built into the device firmware. In another embodiment, the persistent payment soft button 7510 may be built into the operating system, or into another component or module of the device. In an embodiment, persistent payment button 2210C may be a physical, e.g., a hard button that is built into the device. For example, persistent payment button 2210C may be implemented as a persistent payment hard button 7512 that is built into the device. In another embodiment, persistent payment hard button 7512 may be programmed to operate as a persistent payment button under particular conditions, e.g., when a particular module is active, or when a particular condition is met. In an embodiment, for example, one or more devices with a persistent payment hard button 7512A may be provided when a user enters a retail store. For example, a wholesale superstore, e.g., a Wal-Mart, may hand out user devices having a persistent payment hard button 7512A to users as they enter the store, in order to facilitate one or more transactions.

In an embodiment, a module 2250 displays a single pay button on the user device. In an embodiment, module 2250 may include condition checking module 7522. Condition checking module 7522 may check one or more conditions to determine, e.g., when a particular module is active, or whether a particular condition is met. In an embodiment, module 2250 may include vendor communication maintaining module. Vendor communication maintaining module 7524 may include a communication module for communicating with the vendor through one or more networks or other media. For example, a user device may communicate with the vendor through a closed vendor network, or through a wireless network provided by the vendor, or through a 4G LTE network provided by an unrelated communication network provider. In an embodiment, module 2250 may include payment channel monitoring module 7526. Module 7526 may monitor one or more payment channels of the user, the user device, or the vendor, and update if one or more of the monitored payment channels changes or becomes active or inactive.

In an embodiment, an input receiving module 7530 may receive input from the persistent payment button 2210C. For example, module 7530 may include button pushing receiving module 7532, which may detect when the persistent payment button 7532 is pressed. In another embodiment, however, persistent payment button 2210C may not be a button, but some other sort of non-button trigger, e.g., a gesture made while operating an augmented reality device, or an infrared signal. In an embodiment, non-button interface receiving module 7532 of input receiving module 7530 may receive the input indicating a potential transaction from the non-button implementation of the persistent payment button.

Then, in an embodiment, using methods previously described, a vendor payment channel acquiring module 2252 acquires an indication that the persistent payment button has been activated, and acquires, e.g., detects, receives, retrieves, or otherwise obtains, the vendor payment channel, e.g., using the vendor payment channel detecting module 2254, partly to detect the vendor payment channels. In an embodiment, vendor payment channel detecting module 2254 may access one or more external resources 2280, as previously described. Specifically, in an embodiment, vendor payment modality and option application module 2256 may apply the selected payment modality and option to execute the user's request to initiate payment, using the persistent payment button, and transparently, or partially transparently to the user, with the context of the device (e.g., location, and other factors) determining what specifically the persistent payment button carries out. In an embodiment, vendor payment channel acquiring module 2252 may include vendor transmission of payment options and/or payment modalities receiving module 7528, which may receive one or more payment options and/or one or more payment modalities from the vendor.

In an embodiment, multi-purpose device 7500 may also include an automated user payment channel selection module 7540, which, in an embodiment, may select a user payment channel for use in carrying out at least a portion of the transaction. In an embodiment, the selection may occur without user intervention. In another embodiment, the selection may include user intervention. Module 7540 may include one or more of payment channel comparator module 7542, weighted payment channel selecting module 7544, and payment channel selecting with non-user external automated input module 7546, which may select a user payment channel automatically, e.g., without further user input after the transaction has been initiated. In an embodiment, e.g., with the use of input module 7546, the process of selecting a user payment channel may be influenced or directly controlled by an external resource, which may or may not be related to the user or the user device.

In an embodiment, multi-purpose device 7500 may include selected automated user payment channel adaptation to one or more vendor payment channel modules 7550. For example, in an embodiment, module 7550 may include vendor payment modality and option application module 2256 may include external resource for payment channel utilizing module 2258, which may be configured to use one or more external resources to complete payment using a context-dependent vendor channel, e.g., through one or more external resources 2280.

In an embodiment, multi-purpose device 7500 may include potential transaction facilitating module 7560, which may include one or more communication modules for communicating with the vendor for which the potential transaction is being negotiated. In an embodiment, potential transaction facilitating module 7650 may include vendor payment systems communication module 7562.

In an embodiment, multi-purpose device 7500 may be implemented with one or more options or modifications. For example, in an embodiment, multi-purpose device 7500 may be implemented as described in payment option hard cap limiter 7520A. In that example, a user has more goods in his or her shopping cart than what he or she has funds to pay with using one or more user payment options of the user payment channel set. Using payment option hard cap limiter 7520A, a user may take items out of his or her shopping cart (which may exist in any known implementation, whether virtual or real), until a signal, e.g., the payment button changes or lights up, or some other appropriate signal, indicating that there are enough funds in the account to pay for the items.

In an embodiment, multi-purpose device 7500 may be implemented as payment option soft cap limiter example 7520B. For example, in an embodiment, a user may add things to his or her shopping car (again, which may be virtual or physical) until the button goes out, indicating he has overstepped how much funds are in the account, or how many funds have been allocated from the account for this purpose. For example, this could be implemented as a type of budgetary control (e.g., only allowed to spend up to $50 per month at Best Buy), or could be used by parents/spouses/siblings etc. to control spending (e.g., “my thirteen year old son can access my account to pay for things when he is at the comic book store today, but only up to twenty-five dollars).

In an embodiment, multi-purpose device 7500 may be implemented as gift car usage maximizer 7520C. For example, in an embodiment, a user may have an undetermined amount of value remaining on a gift card and the pay button may illuminate or otherwise change shape, form, status, or similar appearance when the items reach a certain value that is close to the total value of the gift card. For example, the payment bar could be realized in multi-colors, e.g., red and green, and the amount of green in the button indicates how much of the gift card would be utilized by the purchases currently in the shopping cart.

In an embodiment, multi-purpose device 7500 may communicate with a retail store front, e.g., retail store front 7570. In an embodiment, a device with a “pay” button, e.g., device 2121, may interface with the retail store front 7570. In an embodiment, a retail store front 7570 may include a receiving one or more devices configured to have a button that interacts and/or responds to the retail vendor module 7572, a distributing the one or more devices to one or more users upon entry to the retail dressage module 7574, communicating with the one or more devices to change the button status based on one or more conditions module 7578 (e.g., it is noted that, in an embodiment, this module may be assisted by or controlled entirely by an external third party), and a facilitating one or more transactions in response to button pressing module 7579. In an embodiment, the modules listed above may be performed by a third party that is not the user or the vendor, but may or may not be related to one or both.

Referring again to FIG. 1, in an embodiment, payment initiation module 2210 may include simple payment initiation module 2210B, which may allow for simple payment of one or more items that the user has indicated. For example, a user wants to pay for an item the user has taken a picture of, or placed in a cart, or grabbed, or otherwise indicated (e.g., looked at and pressed a button while wearing augmented reality glasses), and payment happens automatically, or with the touch of one (or a few) buttons, and the details are hidden from the user for both modality and option. The initiation could also be a time-based event, e.g., the start of a movie, or of a round of a fight, or an inning of a baseball game (e.g., for purchase of concessions).

In an embodiment, there may be an augmented reality device 4100. Augmented reality device 4100 may be a device that is owned by the user, and may be associated with the user, e.g., a pair of glasses, or a watch, or it may be a device that is handed out by the vendor, e.g., similarly to how 3D glasses are handed out at movie theaters. Augmented reality device 4100 may include an actual device, and may also include one or more additional devices that support augmented reality device 4100, whether physically located in proximity to the user (e.g., carried by the user in his or her pocket, or worn) or remote to the user.

In an embodiment, augmented reality device 4100 may include duplication module 4110. Duplication module 4110 may be configured to allow a user to pay for an item the user has taken a picture of, or placed in a cart, or grabbed, or otherwise indicated (e.g., looked at and pressed a button while wearing augmented reality glasses), and payment happens automatically, or with the touch of one (or a few) buttons, and the details are hidden from the user for both modality and option.

In an embodiment, augmented reality device 4100 may include a modality negotiation module 4210 may include a user payment modality preference retrieving module 4212 configured to retrieve a user payment modality preference. For example, if a user is sitting down in a crowded coffee shop, a user may be reluctant to get up to pay for a bagel, and risk losing her seat. In an embodiment, modality negotiation module 4210 may include vendor modality retrieving module 4214, which may retrieve a vendor payment modality similarly to one of the previously described techniques. For example, the device may detect, or is told, that a store in which the user is located only supports barcode payment or shopping cart modalities, but the user doesn't want to, or is physically incapable of, wait/waiting in a checkout line or self-checkout station. In an embodiment, modality selecting module 4220 may select a modality to carry out the user's request to pay for the item without additional help or input form the user. For example, modality selecting module 4220 may include modality interfacing database module 4222 and modality interfacing database data retrieving module 4224. For example, in an embodiment, if insufficient data is found in the modality interfacing database 4222, then use external resources (Internet, Google, an intranet of data from the device manufacturer) to determine how to interface using a modality accepted by the vendor.

In an embodiment, once a modality is selected, and information about how to interface with that modality is attained, then modality interfacing module may interface using the vendor's preferred modality. For example, modality interfacing module 4230 may include, in an embodiment, for example, vendor modality duplication learning module 4232. For example, in the illustrated barcode modality example, the device may retrieve all or a portion of the store's barcode recognition database. It is noted that this retrieval may not involve the vendor, rather, in an embodiment, the device may retrieve this information from a third party that stores these databases, or from various manufacturers of items that the user has selected.

In an embodiment, vendor modality duplication implementing module 4234 may use the data gathered by vendor modality duplication learning module, and use it to implement the data, e.g., in the example, retrieving the barcode of the item the user wants to purchase, e.g., by using an image processing sensor of the device.

In an embodiment, modality interfacing module 4230 also may include vendor modality duplication interfacing module 4236, which may be configured to interact with the vendor. For example, in the illustrated example, the vendor may have a vendor barcode reading device 6000. Vendor barcode reading device 6000 may include a barcode reader 60002, an input/output (which may be as simple as an LED) 6004, a store back-end 6008, and data processing unit 6006 that processes the data read in by the barcode reader 6002. In an embodiment, vendor modality duplication interfacing module 4236 interacts with the data processing unit 6006 of the vendor barcode reading device 6000 to deliver the obtained barcode to the vendor, such that the vendor does not distinguish between the transmission and the usual use of the modality, scanning the barcode at the vendor barcode reading device 6000.

In an embodiment, modality interfacing module 4230 also may include a transaction completing module 4238, which completes the transaction and may inform the user.

In an embodiment, a vendor device and/or system 6100 may interact with the system as previously described. In an embodiment, vendor system 6100 may include a vendor payment channel set communicating module 2610. For example, vendor payment channel set communicating module 2610 may include vendor payment channel set broadcasting module 2612, which may be configured to broadcast information, e.g., using vendor payment option set broadcasting module 2612A and vendor payment modality set broadcasting module 2612B.

In an embodiment, vendor payment channel set communicating module may include one or more of vendor payment communication negotiation with user device module 2614, which may include vendor payment option communication negotiation with user device module 2614A and vendor payment modality communication negotiation with user device module 2614B, vendor payment channel set determining module 2616, and vendor payment channel set monitoring module 2618. In an embodiment, for example, an example vendor may have exemplary vendor payment modality set 2604EX, and exemplary vendor payment option set 2602EX, which have been previously described herein, and which are selected merely for exemplary purposes and are non-limiting.

In an embodiment, vendor device 6100 may include vendor mass payment with variable payment channels system 6200. For example, in various circumstances, a vendor may want to process payments from lots of users that use different modalities, e.g., in a movie theater, people may have items that they've purchased, or a set of people might be waiting in line for a new type of tablet device or video game. Vendor variable payment channels system 6200, in an embodiment, may be designed to facilitate all these people's different payment channels (modalities and options) and process them.

In an embodiment, vendor device 6100 may include vendor operation implementation module 2620, which describes how a vendor may implement a similar system to as described with respect to user device 120. For example, in an embodiment, vendor operation implementation module 2620 may include vendor detection of a potential transaction module 2622. Module 2622 may detect that a transaction is about to take place, which may be based on vendor equipment, or based on a change in conditions, e.g., a position of a user. For example, module 2622 may be triggered, for example, by a user walking up to a self-checkout window in a grocery store, and hitting “start” on the screen.

In an embodiment, module 2620 may include a vendor payment channel obtaining module 2624. Vendor payment channel obtaining module 2624 may include vendor payment option obtaining module 2624A and vendor payment modality obtaining module 2624B. Vendor payment option obtaining module and vendor payment modality obtaining module may work similarly to their counterpart modules in the user device, e.g., vendor payment channel obtaining module 2410, with the exception that the vendor payment channel set may be stored locally.

In an embodiment of the invention, module 2620 may include a user payment channel obtaining module 2626. User payment channel obtaining module 2626 may include user payment channel obtaining module 2626A and user payment modality obtaining module 2626B. Similarly to as above, user payment channel obtaining module 2626 may operate in a similar manner to user payment channel obtaining module 2240, except that because the user payment channel data will probably be remote to vendor device 6100, the techniques for obtaining payment channel data in module 2410 also may be used, as described herein.

In an embodiment of the invention, module 2620 may include a payment channel determining module 2628. Payment channel determining module may select one or more of a payment option and a payment modality, similarly to as described in module 2501. Also similarly to module 2501, external resources may be used, for example, as detailed in payment option interfacing module 2550 and payment modality interfacing module 2640.

In an embodiment of the invention, module 2620 may include transaction facilitating module using determined payment channel 2629, which may facilitate the transaction using the selected payment channel and payment modality, similarly to as described in module 4000.

In an embodiment of the invention, an application module 3500 may be implemented by a program or application designer. The application may reside at various levels within the device, e.g., the application may be part of the kernel, part of the firmware, part of the operating system, it may be a preinstalled program or an essential program, or an independent program. The application may be implemented as an API or through any other known means of implementing an application, including hardware, software, firmware, programmable hardware, and others.

In an embodiment, an application module 3500 may include or interface with potential transaction detecting module 3510. In an embodiment, potential transaction detecting module may perform example 3510A of detecting a transaction or a potential for a transaction. In an embodiment, module 3510 may include one or more of device interface monitoring/communicating module 3512, device information gathering module 3514, device social network monitoring module 3516, device third party data regarding potential transaction receiving module 3518, and application communication with vendor facilitating module 3519.

In an embodiment, an application module 3500 may include or interface with a user payment channel obtaining module 3520. In an embodiment, user payment channel obtaining module 3520 may obtain, e.g., generate, receive, retrieve, or otherwise acquire a user payment channel from one or more sources. In an embodiment, user payment channel obtaining module 3520 may obtain a user payment channel set, and select a user payment channel from that user payment channel set. In an embodiment, user payment channel obtaining module 3520A may include one or more of application obtaining from device module 3522, application obtaining from vendor module 3524, application obtaining from third party module 3526, and application inferring module 3528.

In an embodiment, an application module 3500 may include or interface with a vendor payment channel obtaining module 3530. For example, in an embodiment, user vendor payment channel obtaining module 3530 may include obtaining the vendor payment channel from one or more sources 3530A. In an embodiment, vendor payment channel obtaining module 3530 may obtain a vendor payment channel set, and select one or more of a vendor payment option and/or a vendor payment modality, e.g., a vendor payment channel, from the vendor payment channel set. In an embodiment, vendor payment channel obtaining module may include one or more of application obtaining from device using device I/O module 3532, application obtaining from vendor directly module 3534, application obtaining from third party module 3536, application inferring module 3538, and application receiving vendor information from developer module 3539.

In an embodiment, an application module 3500 may include or interface with a payment channel set union obtaining module 3540, which, in an embodiment, may determine a usable payment channel set 3540A. In an embodiment, the payment channel set union obtaining module 3540 may include one or more of set comparator module 3542 and comparator output analyzing module 3544. In an embodiment, payment channel set union obtaining module 3540 may include or interface with empty set processing module 3560 or selected payment option and modality obtained from union set 3550 (e.g., which may include weighted union set analyzing module 3552), depending on whether there is union between a user payment channel set and a vendor payment channel set. If there is no union between the user payment channel set and the vendor payment channel set, processing moves to one or more of payment option interfacing module 2550 and/or payment modality interfacing module 2640, which are described in more detail elsewhere.

In an embodiment, vendor variable payment channels system 6200 may include a device payment channel determining module 6210 configured to communicate with the device to determine a device's payment channel. In an embodiment, vendor variable payment channels system 6200 also may include pay now instruction transmitting module 6212, and device payment acceptance module 6214, used to interface with the device modality as previously described. It is noted that the process by which this is carried out, as previously described with respect to user device 120, may take place at the vendor, at the user device, or partially at each of the devices, or using a third party device. In an embodiment, this process is repeated for all of the devices that are detected by the vendor mass payment system 6200. It is noted that although system 6200 is called vendor mass payment system 6200, that is merely for illustrative purposes, and in an embodiment, system 6200 may be provided by a third party, e.g., a device manufacturer, that may put limits on what kinds of devices are eligible for the mass payment system (e.g., only Samsung-branded phones are eligible, or only phones communicating on a 4G LTE network are eligible).

In an embodiment of the invention, a device, e.g., device 6500, may be used as a device intermediary, as previously described, with respect to module 2670. For example, a person or entity may authorize their device to act as a payment intermediary for one or more stores (and could be context-dependent, e.g., the store the person is in), where the device uses one or more modalities accepted by the vendor, and the device agrees to act as a broker, in exchange for some sort of reimbursement, from the vendor, or user, or a third party, or positive publicity (e.g., a tweet sent out from a user's twitter account that acknowledges the device owner). In an embodiment, device 6500 may include a condition defined as acceptable for a device to act as an intermediary detecting module 6510. Module 6510 may perform calculations or receive instructions, e.g., from a user, or from a third party with limited agency over the device, that determine when device 6500 is allowed to act as an intermediary. For example, module 6510 may include determining one or more conditions that permit the device to act as an intermediary device for unrelated devices module 6512, which may determine a condition under which device 6500 will act as an intermediary. In an embodiment, module 6510 also may include a detecting one or more of the determined conditions that permit the device to act as an intermediary device for unrelated devices module 6514, which may detect, or be informed of, one or more acceptable conditions. An example of one or more conditions may be that a device is set to act as an intermediary to unrelated devices when the device is located at an upscale shopping mall. Another example may be that a device is set to act as an intermediary to unrelated devices when the device is located at a store that is part of a particular corporate chain. Another example may be that a device is set to act as an intermediary to unrelated devices when the device is located at a store that accepts a particular type of payments (e.g., Google Wallet).

In an embodiment of the invention, device 6500 may include availability as an intermediary informing module 6520, which communicates availability as an intermediary device to a variety of devices through one or more methods. In an embodiment, module 6520 may include one or more of Signal Broadcasting Module 6522 for broadcasting a signal indicating availability as an intermediary that can be picked up by the client device, Vendor Communication and/or Registration Module 6524 for contacting the vendor and registering the device as available to perform intermediary work, Listening for Devices Module 6526 for listening to communication involving one or more client devices and/or offering/soliciting as an intermediary, and Third Party Requestor Communication Module for receiving communication from a non-vendor third party (e.g., a service provider to the vendor or to the client) requesting assistance as an intermediary 6528.

In an embodiment of the invention, device 6500 may include Intermediary Acceptance Module 6530 which may accept to act as an intermediary for the client device. This module may include intermediary compensation and/or agreement terms negotiating module 6532 and/or client data collecting module 6534. In an embodiment of the invention, device 6500 may include Intermediary Performance Module 6540 for performing intermediary assistance in payment option and/or payment modality between client (user) and vendor.

Referring again to FIG. 1, a manufacturer marketplace may act as an intermediary, as described in step 2554. Such an intermediary may include developer marketplace 6600. For example, a store operated by the operating system manufacturer of the device (e.g., the Microsoft Xbox games store for a device running a Microsoft operating system, e.g., Windows Phone 8.0, receives a request to assist with a transaction, e.g., purchasing a coffee at a coffee shop. The marketplace may collect data regarding payment channels of the coffee shop and the client device that is attempting to purchase the coffee. The marketplace then may provide the payment to the vendor for a transaction, using a payment channel that the client device does not have access to, and then may use its own existing payment channel with the client device to recapture the cost of the transaction.

In an embodiment, marketplace 6600 may include Request for Payment Channel Assistance Receiving Module 6610. For example, an online shopping marketplace (e.g., a transaction facilitator, e.g., the Apple App Store, or Google Play Store) receives a request for assistance with one or more payment channels and/or payment modalities from the client device. IN an embodiment, marketplace 6600 may include payment channel data gathering module 6620, which may be configured to gather information about the payment channels used by the client and the vendor, either directly from one or more of the client and/or vendor, or from other devices in the area.

In an embodiment, marketplace 6600 may include a Payment Channel Vendor Payment Facilitating Module 6630 configured to assist in providing payment to the vendor, utilizing one or more tools at its disposal, including possibly third party devices not under the direct control of the vendor, portions of the client device, the vendor device, or other resources.

In an embodiment, marketplace 6600 may include a Payment Channel Client Reimbursement Facilitating Module 6640 configured to, if necessary, if the vendor used one or more payment channels not directly involving the client device, the marketplace uses its payment channels, e.g., which may be preexisting due to the client relationship with the marketplace to collect the cost of the transaction from the client device. In another embodiment, marketplace 6600 may include marketplace as identifier tool module 6635 configured to may work with the vendor to confirm or certify an identity of the client device, in order to facilitate the transaction (e.g., which may be credit or accounts-payable based), rather than actually carry out the transaction.

Referring again to FIG. 1, e.g., FIG. 1H, other alternatives may be incorporated into the system. Some exemplary examples of these alternatives may include a frequent shopper reward application module 2190 that ensures that a user's frequent shopper cards are available as an option, or are automatically applied, a device search engine interface 2350, which goes to a search engine to get instructions to figure out how to interface with a particular payment channel, e.g., option or modality. In an embodiment, the system may include a credit card rewards program maximize module 2130 that may be configured to determine which credit card of a set of credit cards of the user to apply as the payment option to maximize user rewards, which may be based on an efficiency algorithm or a user preference that has been entered into the device.

In an embodiment, the system may include a trusted device voucher module 2354A, which, in an embodiment, in trying to verify the identity of a user, the vendor asks a device it trusts, e.g., a device it authenticates through a different means, to verify that the user device is legitimate. For example, a user's brother might not want to authenticate, or be unable to authenticate, so the user authenticates to the store with the user's device. The store then asks the user to verify that the person is indeed the user's brother. It could be limited to preexisting relationships, or types of relationships, e.g., blood relationships, marriage relationships, and familial relationships, or could use contact list information, or social network information.

In an embodiment, the system may include friendly device search interface 2360 configured to search the area to determine whether there are any devices that share a characteristic with the user device that ire in the vicinity.

In an embodiment, the system may include a small business assistance module 2140 configured to figure out whether a user wants to use a corporate card or not, e.g., based on one or more of where the user is located, what store the user is located in, what the user is buying, who the user is with, and the like.

In an embodiment, the system may include a frequent shopper card guaranteed use module 2150 configured to ensure that a user's frequent shopper card number is engaged when the purchase is completed, so that the user gets the credit.

Referring now to FIG. 2, FIG. 2 illustrates an example environment 200 in which the methods, systems, circuitry, articles of manufacture, and computer program products and architecture, in accordance with various embodiments, may be implemented by one or more user devices 220. As shown in FIG. 2A, one or more user devices 220, intermediate devices 230, external devices 240, and vendor devices 280 may communicate via one or more communication networks 260. In an embodiment, intermediate device(s) 230 may include intermediate device “A” 232 and/or intermediate device “B” 234. In an embodiment, vendor device 280 may include a vendor transaction processing system 282, a vendor interface system 284, and may include a vendor payment channel set 204, which may include one or more of a vendor payment modality set 204A and a vendor payment option set 204B. These will be discussed in more detail herein with respect to specific examples.

In an embodiment, external device 240 may include one or more of device list 242, vendor list 244, device communication interface 246, and vendor communication interface 248. Device 240 is listed as “external” not because it is necessarily external in temporal location or function, because in an embodiment, it may not be, but because external device 240 is not under the control of vendor device 280, user device 220, or intermediate device(s) 230, although any or all of the foregoing may communicate with external device 240.

User device 220 may be any electronic device, portable or not, that may be operated by or associated with one or more users. User device 220 is shown as interacting with a user 105. As set forth above, user 105 may be a person, or a group of people, or another entity that mimics the operations of a user. In an embodiment, user 105 may be a computer or a computer-controlled device. User device 220 may be, but is not limited to, a cellular phone, a network phone, a smartphone, a tablet, a music player, a walkie-talkie, a radio, a USB drive, a portable solid state drive, a portable disc-type hard drive, an augmented reality device (e.g., augmented reality glasses and/or headphones), wearable electronics, e.g., watches, belts, earphones, or “smart” clothing, earphones, headphones, audio/visual equipment, media player, television, projection screen, flat screen, monitor, clock, appliance (e.g., microwave, convection oven, stove, refrigerator, freezer), a navigation system (e.g., a Global Positioning System (“GPS”) system), a medical alert device, a remote control, a peripheral, an electronic safe, an electronic lock, an electronic security system, a video camera, a personal video recorder, a personal audio recorder, and the like.

In an embodiment, user device 220 may be associated with user 105, and vendor device 280 may be associated with vendor 106. In an embodiment, user 105 may want to acquire goods and/or services from vendor 106, in what will be referred to throughout this application as a “transaction.” It is noted that “transaction” does not necessarily limit to the payment for a good or service. The transaction may incorporate such things as the user selecting an item, or requesting more information about an item from the vendor

In an embodiment, user 105 and user device 220 may facilitate the transaction using a user payment channel. A user payment channel may include one or more of a user payment modality and a user payment option. A user payment modality may be a method by which the user compensates the vendor for the one or more goods and services. A user payment option may be a specific type or form of payment that the user attempts to compensate the vendor for the goods or services. Examples of user payment options and user payment modalities are found in FIG. 1.

In an embodiment, vendor 106 and vendor device 280 may facilitate the transaction using a vendor payment channel. A vendor payment channel may include one or more of a vendor payment modality and a vendor payment option. A vendor payment modality may be a method by which the vendor compensates the vendor for the one or more goods and services. A vendor payment option may be a specific type or form of payment that the vendor attempts to compensate the vendor for the goods or services. Examples of vendor payment options and vendor payment modalities are found in FIG. 1.

In an embodiment, the user may wish to use the user payment channel to complete the transaction, regardless of what the vendor payment channel is. In an embodiment, the user may desire to not know what the vendor payment channel is, only that the transaction can be completed without the user changing his user payment channel to match the vendor payment channel. In an embodiment, there may not be an overlap, or a complete overlap, between the user payment channel and the vendor payment channel. In such instances, device 280 may form a sort of agnostic payment system, where to the user, it appears that only user payment channels are used, and the vendor payment channels are interfaced transparently to the user 105.

Referring now to FIG. 2B, device 280 may include an operating system 224 with a kernel 223. In this context, operating system 224 refers to any hardware, software, firmware, and combination thereof which is considered at the core or baseline of a device. For example, applications that interact directly with hardware may be considered to be part of an operating system. In an embodiment, operating system 224 may be an FPGA, printed circuit board, or other wired device. In an embodiment, operating system 224 may include one or more of Google's Android, Apple's iOS, Microsoft's Windows, various implementations of Linux, and the like. In an embodiment, operating system 224 may include a root menu for one or more televisions, stereo systems, media players, and the like. In an embodiment, operating system 224 may be a “home” or base screen of a device.

Referring again to FIG. 2B, in an embodiment, device 280 may include a vendor interface system 284. Vendor interface system 284 may include any hardware, software, firmware, and combination thereof that allow interaction device 280. In an embodiment, vendor interface system 284 may include a monitor, screen, touchscreen, liquid crystal display (“LCD”) screen, light emitting diode (“LED”) screen, speaker, handset, earpiece, keyboard, keypad, touchpad, mouse, trackball, remote control, button set, microphone, video camera, still camera, a charge-coupled device (“CCD”) element, a photovoltaic element, and the like.

Referring again to FIG. 2B, in an embodiment, device 280 may include a device memory 226. In an embodiment, device memory 226 may include memory, random access memory (“RAM”), read only memory (“ROM”), flash memory, hard drives, disk-based media, disc-based media, magnetic storage, optical storage, volatile memory, nonvolatile memory, and any combination thereof. In an embodiment, device memory 226 may be separated from the device, e.g., available on a different device on a network, or over the air. For example, in a networked system, there may be many devices 280 whose device memory 226 is located at a central server that may be a few feet away or located across an ocean. In an embodiment, device 280 may include a device memory 226. In an embodiment, memory 226 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In an embodiment, memory 226 may be located at a single network site. In an embodiment, memory 226 may be located at multiple network sites, including sites that are distant from each other.

Referring again to FIG. 2B, device memory 226 may include, for example, payment data conversion tables 226A, which may be used in implementations as discussed in more detail herein.

Referring again to FIG. 2B, in an embodiment, device 280 may include vendor transaction processing system 282. In an embodiment, vendor transaction processing system 282 may include components for processing transactions, including any component that allows the device to interact with its environment. For example, in an embodiment, vendor transaction processing system 282 may include one or more sensors, e.g., a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), a radio, including a wireless radio, a transmitter, a receiver, an emitter, a broadcaster, and the like.

Referring again to FIG. 2B, device 280 may include a detecting system 283 for detecting various conditions, in some embodiments, doing so in accordance with the vendor transaction processing system 282 including one or more of the sensors described above. Detecting system 283 may include a condition detecting system 283A which may include functionality for detecting particular conditions, as described in the specific embodiments further herein. In an embodiment, detecting system 283 may include a client device detecting system 283B for detecting the set of two or more client devices. In various embodiments, detecting system 283 may receive data, rather than collecting data, or may carry out a combination of receiving, collecting, generating, and/or processing data. Detecting system 283 may interact with processor 222 and processing module 250.

Referring again to FIG. 2B, device 280 may include an external resource managing system 285 that manages external resources, as described in more detail further herein. Managing external resources may include an external resource contacting module 285A which may contact external resources, find external resources, and/or maintain contact with external resources, as described in more detail herein. In an event that an external resource is used to facilitate a transaction, external resource negotiating module 285B may be used to negotiate with one or more external resources, in conjunction with one or more modules of processor 222.

Referring again to FIG. 2B, FIG. 2B shows a more detailed description of device 280. In an embodiment, device 280 may include a processor 222. Processor 222 may include one or more microprocessors, Central Processing Units (“CPU”), a Graphics Processing Units (“GPU”), Physics Processing Units, Digital Signal Processors, Network Processors, Floating Point Processors, and the like. In an embodiment, processor 222 may be a server. In an embodiment, processor 222 may be a distributed-core processor. Although processor 222 is as a single processor that is part of a single device 280, processor 222 may be multiple processors distributed over one or many devices 280, which may or may not be configured to operate together. Processor 222 is illustrated as being configured to execute computer readable instructions in order to execute one or more operations described above, and as illustrated in FIGS. 6, 7A-7C, 8A-8H, and 9A-9C. In an embodiment, processor 222 is designed to be configured to operate as processing module 250, which may include one or more of request to carry out at least one particular transaction with a set of two or more client devices that have a particular property in common acquiring module 252, vendor payment channel from vendor payment channel set adapting for use with an acquired first user payment channel associated with a first device of the set of two or more client devices in order to facilitate at least a portion of the particular transaction module 254, and vendor payment channel from vendor payment channel set adapting for use with an acquired second client payment channel different than the first client payment channel and associated with a second device of the set of two or more client devices, in order to facilitate at least a portion of a further transaction module 256.

Referring now to FIG. 2C, FIG. 2C shows an implementation of device 280 as vendor device 280′. This example is intended to show one example, of many possible examples, of a use of device 280. This example should not be interpreted as limiting in any way, or limiting any claims to the particular embodiment shown in FIG. 2C. FIG. 2C is merely an illustration of an exemplary way of implementing device 280. Other methods of implementing the systems claimed herein are described in this specification, and if they are not explicitly drawn out in diagrams, no inference of any kind, whether positive or negative, should be drawn from their omission, as it is not practical to specifically illustrate every example enumerated in this application.

Referring again to FIG. 2C, FIG. 2C shows an example implementation in a movie theater, including a screen 110 of the device 280. Inside the movie theater, there are various client devices, including client device “A” 220A, client device “B” 220B, client device “C” 220C, and client device “D” 220D. Also illustrated are intermediate device “A” 232A and intermediate device “B” 232B. Each of the client and intermediate devices are positioned in seats 112 of the movie theater. The client devices may be any kind of device, including devices mounted into chairs, or devices carried by various users seated in the respective seats. A set of client devices 220Z includes client device 220A, client device 220B, client device 220C, and intermediate device 232A. It is noted that a set of client devices, including a set of two or more client devices, may not include every device, and may include intermediate devices as client devices.

Client device 220A may include a client payment channel set 221A, including a client payment option set 222A and a client payment modality set 223A. Client device 220B may include a client payment channel set 221B, including a client payment option set 222B and a client payment modality set 223B. Client device 220C may include a client payment channel set 221C, including a client payment option set 222C and a client payment modality set 223C. Client device 220D may include a client payment channel set 221D, including a client payment option set 222D and a client payment modality set 223D.

Referring again to FIG. 2C, vendor device 280′ may include a vendor payment channel set 204′. Vendor payment channel set 204′ may include one or more of a vendor payment modality set 204A′ and a vendor payment option set 204B′. In an embodiment, at a particular time, e.g., when a movie starts, or five minutes before a movie, or ten minutes after, or any other particular time, vendor device 280′ may collect payment from the set of client devices 220Z. Payment may be collected for a movie ticket, or for concession or other items purchased for the movie, or both, or some other transaction may be carried out. In an embodiment, client device detecting module 281A detects a set of client devices including client device 220A and client device 220B. In an embodiment, client device payment channel obtaining module 281B obtains the client payment channel set 221A from client device 220A and the client payment channel set 221B from client device 220B. In an embodiment, client data obtaining module 281C may obtain further data from or about the client devices and/or the client payment channel sets. If the client payment channel set is present in the vendor payment channel set 204, then the transaction can be completed by payment collecting module 281E. If the client payment channel set, e.g., client payment channel set 221A of client device 220A, is not present in vendor payment channel set 204′, then resource interfacing module 281D may obtain a resource, e.g., intermediate device 232A, for assistance in completing the transaction. For example, intermediate device 232A may include the client payment option set 222A, and the vendor payment option set 204B′. In an embodiment, intermediate device 232A then may receive instructions to collect payment from client device 220A using the client payment option set 222A, and then may receive instructions to submit payment to the vendor device 280′ using vendor payment option set 204B′.

In this manner, all of the client devices in the set of client devices may successfully submit payment, without requiring additional action from the respective clients, and without the respective clients leaving their seats. In an embodiment, client device 220A, which may use an intermediary, and client device 220B, which may not, may appear to their respective users to have carried out their transactions directly with the vendor device 280′

Referring now to FIG. 3, FIG. 3 illustrates an exemplary implementation of the request to carry out at least one particular transaction with a set of two or more client devices that have a particular property in common acquiring module 252. As illustrated in FIG. 3, the request to carry out at least one particular transaction with a set of two or more client devices that have a particular property in common acquiring module may include one or more sub-logic modules in various alternative implementations and embodiments. For example, as shown in FIG. 3, e.g., FIG. 3A, in an embodiment, module 252 may include one or more of request to carry out a payment collection for one or more of a particular set of goods and/or services with a set of two or more client devices configured to submit payment for one or more of the particular set of goods and/or services acquiring module 302, request to carry out at least one particular transaction with a set of two or more client devices that have a particular property in common receiving module 306, and request to carry out at least one particular transaction with a set of two or more client devices that have a particular property in common generating module. In an embodiment, module 302 may include request to carry out a payment collection for purchase of a ticket with a set of two or more client devices configured to submit payment for the ticket acquiring from a theater operator module 304. In an embodiment, module 308 may include request to carry out at least one particular transaction with a set of two or more client devices that have a particular property in common generating in response to detection of a particular indicator module 310. In an embodiment, module 310 may include one or more of request to carry out at least one particular transaction with a set of two or more client devices that have a particular property in common generating in response to detection of a particular number of client devices within a detected range module 312, request to carry out at least one particular transaction with a set of two or more client devices that have a particular property in common generating in response to receipt of a particular number of request indicators to carry out the particular transaction module 314, and request to carry out at least one particular transaction with a set of two or more client devices that have a particular property in common generating in response to receipt of an event indicator module 316.

Referring again to FIG. 3, e.g., FIG. 3B, in an embodiment, module 252 may include one or more of request to carry out at least one particular transaction with a set of two or more client devices that have a particular device characteristic in common acquiring module 318 and request to carry out at least one payment receipt transaction with a set of two or more client devices that have a particular property in common acquiring module 328. In an embodiment, module 318 may include one or more of request to carry out at least one particular transaction with a set of two or more client devices that have a common component manufacturer acquiring module 320, request to carry out at least one particular transaction with a set of two or more client devices that have a common operating system acquiring module 322, request to carry out at least one particular transaction with a set of two or more client devices that have a particular program loaded in device memory in common acquiring module 324, and request to carry out at least one particular transaction with a set of two or more client devices that are communicating using a same particular communication network acquiring module 326.

Referring again to FIG. 3, e.g., FIG. 3C, in an embodiment, module 252 may include one or more of request to carry out at least one item valuation transaction with a set of two or more client devices that have a particular property in common acquiring module 330, request to carry out at least one particular transaction with a first client device of the set of two or more client devices and to carry out at least one further transaction with a second client device of the set of two or more client devices that have a particular property in common acquiring module 332, request to carry out at least one particular transaction with a first client device of the set of two or more client devices and to carry out at least one particular transaction with a second client device of the set of two or more client devices that have a particular property in common acquiring module 334, set of two or more client devices having a particular property of being configured to carry out the particular transaction in common detecting module 336, and request to carry out the at least one the particular transaction with at least two of the detected set of two or more client devices module 338. In an embodiment, module 336 may include set of two or more client devices having the particular property of being configured to carry out the particular transaction in common and that meet a particular criteria detecting module 340. In an embodiment, module 340 may include set of two or more client devices having the particular property of being configured to carry out the particular transaction in common and that are associated with respective clients having a particular customer profile detecting module 342.

Referring now to FIG. 4, FIG. 4 illustrates an exemplary implementation of vendor payment channel from vendor payment channel set adapting for use with an acquired first user payment channel associated with a first device of the set of two or more client devices in order to facilitate at least a portion of the particular transaction module 254. As illustrated in FIG. 4, the vendor payment channel from vendor payment channel set adapting for use with an acquired first user payment channel associated with a first device of the set of two or more client devices in order to facilitate at least a portion of the particular transaction module 254 may include one or more sub-logic modules in various alternative implementations and embodiments. For example, as shown in FIG. 4 (e.g., FIG. 4A), in an embodiment, module 254 may include vendor payment channel from vendor payment channel set interfacing with an acquired first user payment channel associated with a first device of the set of two or more client devices in order to facilitate at least a portion of the particular transaction module 402. In an embodiment, module 402 may include one or more of one or more actions that allow use of the first user payment channel for a first portion of the particular transaction and use of the vendor payment channel for a second portion of the particular transaction executing module 404, portion of the particular transaction using the first device executing using the first client payment channel module 410, and result of executing the portion of the particular transaction using the first device converting for use with the vendor payment channel module 412. In an embodiment, module 404 may include one or more of use of the first client payment channel for the first portion of the particular transaction data receiving module 406 and received data adapting for use with the vendor payment channel as the second portion of the particular transaction module 408.

Referring again to FIG. 4, e.g., FIG. 4B, as described above, in an embodiment, module 254 may include one or more of instruction for adapting the first client payment channel for use with the vendor payment channel providing to the first client device module 414, resource configured to be used to allow the vendor payment channel to be used with the first client payment channel obtaining module 416, and first client payment channel associated with the first device accepting using the obtained resource module 418. In an embodiment, module 416 may include one or more of data stored in a database configured to be used to allow the vendor payment channel to be used with the first client payment channel obtaining module 420 and arbitraging resource configured to be used to allow the vendor payment channel to be used with the first client payment channel obtaining module 424. In an embodiment, module 420 may include data stored in a vendor-specific code translation database configured to be used to allow the vendor payment channel to be used with the first client payment channel obtaining module 422. In an embodiment, module 424 may include arbitraging resource configured to be used to allow the vendor payment channel to be used with the first client payment channel by accepting payment using the first client payment channel and submitting payment using the vendor payment channel obtaining module 426.

Referring again to FIG. 4, e.g., FIG. 4C, in an embodiment, module 254 may include one or more of external device resource configured to be used to facilitate at least a portion of the particular transaction with the first device information obtaining module 428 and data regarding the obtained information regarding the external device resource to the first device configured to use the first client payment channel transmitting module 430. In an embodiment, module 428 may include external device resource configured to be used to facilitate at least a portion of the particular transaction with the first device by using the first client payment channel and to facilitate another portion of the particular transaction using the vendor payment channel information obtaining module 432. In an embodiment, module 432 may include one or more of external device resource configured to use the first client payment channel and configured to use the vendor payment channel information obtaining module 434 and external device resource configured to use the first client payment channel and configured to use the vendor payment channel selecting from a generated list of external device resources module 442. In an embodiment, module 434 may include external device resource configured to use the first client payment channel and configured to use the vendor payment channel selecting from a list of external device resources module 436. In an embodiment, module 436 may include one or more of external device resource configured to use the first client payment channel and configured to use the vendor payment channel selecting from a list of external device resources provided by a first device component manufacturer module 438 and external device resource configured to use the first client payment channel and configured to use the vendor payment channel selecting from a list of external device resources provided by a first device application designer module 440.

Referring again to FIG. 4, e.g., FIG. 4D, in an embodiment, module 254 may include module 428 and module 438, as previously described. In an embodiment, module 428 may include external device resource configured to be used to facilitate at least a portion of the particular transaction with the first device information obtaining by polling at least one device module 444. In an embodiment, module 444 may include one or more of external device resource configured to be used to facilitate at least a portion of the particular transaction with the first device information obtaining by polling the set of two or more client devices module 446 and external device resource configured to be used to facilitate at least a portion of the particular transaction with the first device information obtaining by polling at least one device having a particular property module 448. In an embodiment, module 448 may include one or more of external device resource configured to be used to facilitate at least a portion of the particular transaction with the first device information obtaining by polling at least one device at a particular location module 450 and external device resource configured to be used to facilitate at least a portion of the particular transaction with the first device information obtaining by polling at least one device communicating via a particular communication network module 454. In an embodiment, module 450 may include external device resource configured to be used to facilitate at least a portion of the particular transaction with the first device information obtaining by polling at least one device near a first device location module 452.

Referring again to FIG. 4, e.g., FIG. 4E, in an embodiment, module 254 may include module 428, module 438, module 444, and module 448, as previously described. In an embodiment, module 448 may include one or more of external device resource configured to be used to facilitate at least a portion of the particular transaction with the first device information obtaining by polling at least one device manufactured by a particular manufacturer module 456 and external device resource configured to be used to facilitate at least a portion of the particular transaction with the first device information obtaining by polling at least one device that is configured to execute a particular application module 458. In an embodiment, module 428 may include one or more of external device resource configured to use the first client payment channel and configured to use the vendor payment channel information obtaining module 460 and second device as the external device resource configured to be used to facilitate at least a portion of the particular transaction with the first device selecting module 462.

Referring again to FIG. 4, e.g., FIG. 4F, in an embodiment, module 254 may include one or more of resource configured to be used to link the vendor payment channel with the first client payment channel obtaining module 464 and assistance from the determined resource in facilitating the particular transaction requesting module 466. In an embodiment, module 464 may include resource configured to be used to link the vendor payment channel with the first client payment channel obtaining at least partly based on the first client payment channel module 468. In an embodiment, module 468 may include resource configured to be used to link the vendor payment channel with the first client payment channel obtaining at least partly based on the first client payment channel that includes a first client payment option module 470. In an embodiment, module 470 may include resource that is a facilitator of the first client payment option and is configured to be used to link the vendor payment channel with the first client payment channel obtaining at least partly based on the first client payment channel that includes the first client payment option module 472. In an embodiment, module 466 may include initiation of contact with the first device requesting from the determined resource in facilitating the particular transaction module 474.

Referring again to FIG. 4, e.g., FIG. 4G, in an embodiment, module 254 may include one or more of intermediary device having a particular property and configured to facilitate at least a portion of the particular transaction selecting module 476, agreement to facilitate at least a portion of the particular transaction negotiating with the intermediary device module 478, and intermediary device-related data transmitting to the first device module 480. In an embodiment, module 467 may include one or more of second device as intermediary device selecting module 482, intermediary device having a particular property and configured to facilitate at least a portion of the particular transaction selecting from the set of two or more client devices module 484, intermediary device configured to conduct one or more transactions using the first client payment channel and configured to conduct one or more transactions using the vendor payment channel selecting module 486, and intermediary device configured to execute a particular program and configured to facilitate at least a portion of the particular transaction selecting module 488. In an embodiment, module 478 may include agreement to facilitate compensation to the intermediary device for facilitating a portion of the particular transaction negotiating module 490. In an embodiment, module 480 may include one or more of intermediary location and/or addressing data transmitting to the first device module 492 and intermediary device recognition code data transmitting to the first device module 494.

Referring again to FIG. 4, e.g., FIG. 4H, in an embodiment, module 254 may include transaction using vendor payment channel from vendor payment channel set facilitating at least a portion of the particular transaction such that the first client device is allowed to appear to use the first client payment channel module 496. In an embodiment, module 496 may include one or more of transaction using vendor payment channel from vendor payment channel set facilitating at least a portion of the particular transaction such that the first client device is allowed to appear to use the first client payment channel to a user of the first device module 498, instruction for first device to obtain transaction data at least partly using the first client payment channel providing module 401, instruction for first device to manipulate the transaction data into a format configured to be used with the vendor payment channel providing module 403, and instruction for facilitating the particular transaction using the vendor payment channel providing module 405. In an embodiment, module 401 may include instruction for first device to obtain transaction data in order to appear to a user of the first client device that the first client payment channel is used providing module 407. In an embodiment, module 403 may include one or more resources configured to assist in manipulation of the transaction data into a format configured to be used with the vendor payment channel providing module 409. In an embodiment, module 405 may include one or more of instruction for facilitating the particular transaction using the vendor payment channel without providing direct notification to the user providing module 411.

Referring now to FIG. 5, FIG. 5 illustrates an exemplary implementation of vendor payment channel from vendor payment channel set adapting for use with an acquired second client payment channel different than the first client payment channel and associated with a second device of the set of two or more client devices, in order to facilitate at least a portion of a further transaction module 256. As illustrated in FIG. 5, the vendor payment channel from vendor payment channel set adapting for use with an acquired second client payment channel different than the first client payment channel and associated with a second device of the set of two or more client devices, in order to facilitate at least a portion of a further transaction module 256 may include one or more sub-logic modules in various alternative implementations and embodiments. For example, as shown in FIG. 5, e.g., FIG. 5A, in an embodiment, module 256 may include vendor payment channel from vendor payment channel set adapting for use with an acquired second client payment channel including at least one of a second client payment option and a second client payment modality that is different than the first client payment channel including a first client payment option and a first client payment modality and associated with a second device of the set of two or more client devices, in order to facilitate at least a portion of the further transaction module 502. In an embodiment, module 502 may include one or more of vendor payment channel from vendor payment channel set adapting for use with an acquired second client payment channel including at least one of a specific second client payment option and a specific second client payment modality that is different than the first client payment channel including a first client payment option and a first client payment modality and associated with a second device of the set of two or more client devices, in order to facilitate at least a portion of the further transaction module 504 and vendor payment channel from vendor payment channel set adapting for use with an acquired second client payment channel including at least one of a specific second client payment option that requires fewer steps to carry out than a vendor payment option of the vendor payment channel and a specific second client payment modality that requires fewer steps to carry out than a vendor payment modality of the vendor payment channel that is different than the first client payment channel including a first client payment option and a first client payment modality and associated with a second device of the set of two or more client devices, in order to facilitate at least a portion of the further transaction module 506.

Referring again to FIG. 5, e.g., FIG. 5B, in an embodiment, module 256 may include vendor payment channel that is configured to allow a user of the second device to avoid a particular action from vendor payment channel set adapting for use with an acquired second client payment channel different than the first client payment channel and associated with a second device of the set of two or more client devices, in order to facilitate at least a portion of the further transaction module 508. In an embodiment, module 508 may include one or more of vendor payment channel that is configured to allow a user of the second device to avoid a waiting in a line action adapting for use with an acquired second client payment channel different than the first client payment channel and associated with a second device of the set of two or more client devices, in order to facilitate at least a portion of the further transaction module 510, vendor payment channel that is configured to allow a user of the second device to avoid a getting up from a seat action adapting for use with an acquired second client payment channel different than the first client payment channel and associated with a second device of the set of two or more client devices, in order to facilitate at least a portion of the further transaction module 512, and vendor payment channel that is configured to allow a user of the second device to avoid a providing a physical payment object adapting for use with an acquired second client payment channel different than the first client payment channel and associated with a second device of the set of two or more client devices, in order to facilitate at least a portion of the further transaction module 514.

Referring again to FIG. 5, e.g., FIG. 5C, in an embodiment, module 256 may include one or more of vendor payment channel from vendor payment channel set adapting for use with an acquired second client payment channel present in the vendor payment channel set and associated with a second device of the set of two or more client devices, in order to facilitate at least a portion of the further transaction module 516 and vendor payment channel from vendor payment channel set adapting for use with an acquired second client payment channel that is different than the first client payment channel and also absent from the vendor payment channel set, said second client payment channel associated with a second device of the set of two or more client devices, in order to facilitate at least a portion of the further transaction module 518.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 6 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIGS. 7-9 as well as the other operations to be described herein may be performed by at least one of a machine, an article of manufacture, or a composition of matter.

Referring now to FIG. 6, FIG. 6 shows operation 600, which may include operation 602 depicting acquiring a request to carry out at least one particular transaction with a set of two or more client devices configured to carry out the particular transaction. For example, FIG. 2, e.g., FIG. 2B, shows request to carry out at least one particular transaction with a set of two or more client devices that have a particular property in common acquiring module 252 acquiring (e.g., obtaining, receiving, calculating, selecting from a list or other data structure, receiving, retrieving, or receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds) a request (e.g., the request may be in the form of a signal, e.g., from a component, either external or internal to a device, through any known format, the request may be in the form of data, retrieved from a memory of any kind and at any physical location or arrangement, or in the form of a detectable event, e.g., a user making a particular motion, speaking a particular word, using a particular augmented reality device, and the like) to carry out (e.g., execute, e.g., either in part or in whole) at least one particular transaction (e.g., an exchange of a form of compensation for goods and/or services, whether it actually occurs or not, at any stage, including preparation, selection of an item, verification of a price, verification of an identity, and equivalents) with a set (e.g., the word set throughout this application includes zero, one, two, or more, including the empty set, incomplete sets, and complete sets) of two or more (e.g., any number of client devices that is not one or zero) client devices (e.g., any component or set of components, e.g., a cellular phone, smart phone, IP phone, VOIP phone, handset, microphone, camera (e.g., video camera, still camera, digital camera, and the like), headphone, earpiece, screen, monitor, television, game system, receiver (e.g., an audio/visual receiver), media player (e.g., DVD player, Blu-ray player, CD player, MP3 player, cassette tape player), tablet device, netbook computer, notebook computer, router, wireless router, bridge, network equipment, server, desktop computer, personal computer, personal computer component (e.g., RAM, hard drive, video card, and the like), personal navigation system, vehicle navigation system, motor vehicle, motor vehicle stereo, motor vehicle control system, motor vehicle communication system (e.g., OnStar), appliance, security system (e.g., a home security system), electronic safety device (e.g., an electronic safe, a door security system, a door locking system), stereo system, speaker, remote control (e.g., a universal remote control, or a device remote control), radio, two-way radio, walkie-talkie, ham radio, a metal detector, a radar detector, a weather station, a robot (e.g., a Roomba), a vacuum cleaner, and the like) configured to (e.g., designed to be carried out, or designed in a manner that makes capable of being carried out) carry out (e.g., executed, performed, take a step or measure toward, schedule the performance of, instruct an entity to perform, and the like, including one or more portions of carrying out) the potential transaction (e.g., an exchange of a form of compensation for goods and/or services, whether it actually occurs or not, at any stage, including preparation, selection of an item, verification of a price, verification of an identity, and equivalents).

Referring again to FIG. 6, operation 600 may include operation 604 depicting adapting at least one vendor payment channel of a vendor payment channel set for use with a first client payment channel acquired from a first device of the set of two or more client devices, to facilitate at least a portion of a particular transaction with the first device, wherein the first client payment channel is absent from the vendor payment channel set. For example, FIG. 2, e.g., FIG. 2B, shows vendor payment channel from vendor payment channel set adapting for use with an acquired first user payment channel associated with a first device of the set of two or more client devices in order to facilitate at least a portion of the particular transaction module 254 adapting (e.g., carrying out, fitting, manipulating, modifying, selecting, choosing, making to agree or work with, orienting, acting as a go-between, and the like) at least one vendor payment channel (e.g., one or more of a vendor payment modality (e.g., a method of performing the exchange, a medium by which the exchange takes place, a facilitator of exchange of compensation, and equivalents, that the vendor has available to him or her) and a vendor payment option (e.g., a form of a medium of exchange, e.g., money, currency, credit, and equivalents)) of a vendor payment channel set (e.g., zero, one, or more vendor payment channels) for use with a first client payment channel (e.g., at least one payment option (e.g., a form of a medium of exchange, e.g., money, currency, credit, and equivalents) and/or at least one payment modality (e.g., a method of performing the exchange, a medium by which the exchange takes place, a facilitator of exchange of compensation, and equivalents, that are available)) acquired from a first device (e.g., any component or set of components, including but not limited to, those listed in the previous paragraph) of the set of two or more client devices, to facilitate (e.g., to take one or more steps to assist in the furtherance of, whether successful or not, including actions that record steps or create other steps, and actions that ultimately result in an unintended result) at least a portion of a particular transaction (e.g., an exchange of a form of compensation for goods and/or services, whether it actually occurs or not, at any stage, including preparation, selection of an item, verification of a price, verification of an identity, and equivalents) with the first device (e.g., any component or set of components, including but not limited to, those listed in the previous paragraph), wherein the first client payment channel (e.g., at least one payment option (e.g., a form of a medium of exchange, e.g., money, currency, credit, and equivalents) and/or at least one payment modality (e.g., a method of performing the exchange, a medium by which the exchange takes place, a facilitator of exchange of compensation, and equivalents, that are available)) is absent (e.g., not included, or not included in a same format as, or excluded from) the vendor payment channel set (e.g., zero, one, or more vendor payment channels). A payment option may include, but is not limited to, one or more of, e.g., credit card alpha, credit card beta, store credit card, fuel rewards card, bank gamma debit card, bank delta debit card, corporate credit card, PayPal account, frequent shopper rewards card, nonspecific gift certificate, vendor-specific gift certificate, instant credit approval mechanism, cash, casino chips, tokens, foreign currency, BitCoins, travelers check, bearer bonds, game system points, store credit. A payment modality may include, but is not limited to, one or more of, e.g., credit card verification with swipe only, credit card verification with personal identification number (“PIN”) entry, credit card verification with signature, credit card verification with physical card proximity using radio frequency identifiers (“RFID”), device tap using near field communication (“NFC”), device authentication via wireless network, device authentication via cellular network, indirect device authentication via a device manufacturer network, retinal scan, fingerprint scan, speech recognition, voice recognition, device proxy, password only, trusted device voucher, quick response code, one-dimensional bar code, color barcode, card-embedded microchip, virtual currency transaction, electronic funds transfer, three-dimensional object verification, check authorization, cash anti-counterfeiting procedure

Referring again to FIG. 6, operation 600 may include operation 606 depicting adapting at least one vendor payment channel of the vendor payment channel set for use with a second client payment channel acquired from a second device of the set of two or more client devices, to facilitate at least a portion of a further transaction with the second device, wherein the second client payment channel is different than the first client payment channel. For example. FIG. 2, e.g., FIG. 2B, shows vendor payment channel from vendor payment channel set adapting for use with an acquired second client payment channel different than the first client payment channel and associated with a second device of the set of two or more client devices, in order to facilitate at least a portion of a further transaction module 256 adapting (e.g., carrying out, fitting, manipulating, modifying, selecting, choosing, making to agree or work with, orienting, acting as a go-between, and the like) at least one vendor payment channel (e.g., one or more of a vendor payment modality (e.g., a method of performing the exchange, a medium by which the exchange takes place, a facilitator of exchange of compensation, and equivalents, that the vendor has available to him or her) and a vendor payment option (e.g., a form of a medium of exchange, e.g., money, currency, credit, and equivalents), and the vendor payment channel may be the same as the vendor payment channel used with respect to the first device, or it may be a different vendor payment channel, or a portion may be the same (e.g., the vendor payment modality may be the same and the vendor payment option may be different, or vice versa), of a vendor payment channel set (e.g., zero, one, or more vendor payment channels) for use with a second client payment channel (e.g., at least one payment option (e.g., a form of a medium of exchange, e.g., money, currency, credit, and equivalents) and/or at least one payment modality (e.g., a method of performing the exchange, a medium by which the exchange takes place, a facilitator of exchange of compensation, and equivalents, that are available)) acquired from a second device (e.g., any component or set of components, including but not limited to, those listed in the previous paragraph, that is not the first device, although they may share resources and may be under the control or direction of the same entity) of the set of two or more client devices, to facilitate (e.g., to take one or more steps to assist in the furtherance of, whether successful or not, including actions that record steps or create other steps, and actions that ultimately result in an unintended result) at least a portion of a further transaction (e.g., an exchange of a form of compensation for goods and/or services, whether it actually occurs or not, at any stage, including preparation, selection of an item, verification of a price, verification of an identity, and equivalents, e.g., which may be the same as the particular transaction, related to the particular transaction, or unrelated to the particular transaction), wherein the second client payment channel is different than the first client payment channel (e.g., at least a portion of the second client payment channel is not the same as the first client payment channel).

FIGS. 7A-7E depict various implementations of operation 602, depicting acquiring a request to carry out at least one particular transaction with a set of two or more client devices configured to carry out the particular transaction according to embodiments. Referring now to FIG. 7A, operation 602 may include operation 702 depicting acquiring a request to collect payment for a ticket from a set of two or more devices configured to carry out payment for the ticket. For example, FIG. 3, e.g., FIG. 3A shows request to carry out a payment collection for one or more of a particular set of goods and/or services with a set of two or more client devices configured to submit payment for one or more of the particular set of goods and/or services acquiring module 302 acquiring (e.g., receiving, retrieving) a request (e.g., in data format, from a central device indicating that it is time to collect ticket money) to collect payment for a ticket from a set of two or more devices (e.g., tablets, smartphones, and/or laptop computer devices of people seated on a train) configured to carry out payment for the ticket (e.g., in this example, the devices are configured to carry out payment for the ticket if they are able to connect to a communication network and communicate with the ticket money collecting system).

Referring again to FIG. 7A, operation 702 may include operation 704 depicting receiving a request from a movie theater operator to collect payment for a ticket from a set of three devices carried by three different people sitting in three different rows of a movie theater, prior to a start of a movie. For example, FIG. 3, e.g., FIG. 3A, shows request to carry out a payment collection for purchase of a ticket with a set of two or more client devices configured to submit payment for the ticket acquiring from a theater operator module 304 receiving a request from a movie theater operator (e.g., who pushes a button before the movie starts, causing a request to be generated inside the system) to collect payment for a ticket from a set of three devices carried by three different people sitting in three different rows of a movie theater, prior to a start of a movie.

Referring again to FIG. 7A, operation 602 may include operation 706 depicting receiving a request to carry out at least one particular transaction with a set of two or more client devices configured to carry out the particular transaction. For example, FIG. 3, e.g., FIG. 3A, shows request to carry out at least one particular transaction with a set of two or more client devices that have a particular property in common receiving module 306 receiving a request (e.g., data generated by an internal component) to carry out at least one particular transaction (e.g., receiving payment for groceries in a grocery cart for people waiting in line) with a set of two or more client devices (e.g., the carts are equipped with payment accepting functionality configured to carry out the particular transaction (e.g., paying for groceries in a cart while in a line).

Referring again to FIG. 7A, operation 602 may include operation 708 depicting generating a request to carry out at least one particular transaction with a set of two or more client devices configured to carry out the particular transaction. For example, FIG. 3, e.g., FIG. 3A, shows request to carry out at least one particular transaction with a set of two or more client devices that have a particular property in common generating module 308 generating a request to carry out at least one particular transaction (e.g., determining product numbers of items in a shopping cart to determine a total amount to be charged) with a set of two or more client devices (e.g., smart shopping carts that have items in them that are being wheeled around the grocery store) configured to carry out the particular transaction.

Referring again to FIG. 7A, operation 708 may include operation 710 depicting generating a request to carry out at least one particular transaction with a set of two or more client devices configured to carry out the particular transaction, in response to detection of a particular condition. For example, FIG. 3, e.g., FIG. 3A, shows request to carry out at least one particular transaction with a set of two or more client devices that have a particular property in common generating in response to detection of a particular indicator module 310 generating a request to carry out at least one particular transaction (e.g., executing payment for a particular ice cream item ordered) with a set of two or more client devices (e.g., one or more smartphones, laptops, tablet devices, home computers, smart watches, augmented reality glasses, and similar) configured to carry out the particular transaction (e.g., executing payment), in response to detection of a particular condition (e.g., a button on a register is pressed by a cashier).

Referring again to FIG. 7A, operation 710 may include operation 712 depicting generating a request to carry out at least one particular transaction with a set of two or more client devices configured to carry out the particular transaction, in response to detection of a particular number of client devices in an area. For example, FIG. 3, e.g., FIG. 3A, shows request to carry out at least one particular transaction with a set of two or more client devices that have a particular property in common generating in response to detection of a particular number of client devices within a detected range module 312 generating a request to carry out at least one particular transaction generating a request to carry out at least one particular transaction (e.g., charging users for riding on the subway) with a set of two or more client devices (e.g., subway cards or tokens that the user is carrying), in response to detection of a particular number of client devices in an area (e.g., when there are more than five people in the train car, to initiate payment transactions for the persons and their smart subway cards/tokens that they used to scan themselves into the subway system).

Referring again to FIG. 7A, operation 710 may include operation 714 depicting generating a request to carry out at least one particular transaction with a set of two or more client devices configured to carry out the particular transaction, in response to receiving a particular number of requests from one or more client devices to carry out the particular transaction. For example, FIG. 3, e.g., FIG. 3A, shows request to carry out at least one particular transaction with a set of two or more client devices that have a particular property in common generating in response to receipt of a particular number of request indicators to carry out the particular transaction module 314 (e.g., collect payment for a user's purchases made at a baseball game while the user is in his seat) with a set of two or more client devices (e.g., smart seats that the user is sitting in) configured to carry out the particular transaction (e.g., the seats have been implemented with functionality to determine what a user has ordered (e.g., through manual entry, automatic detection, or other functionality not described in detail here), in response to receiving a particular number of requests from one or more client devices (e.g., the seats) to carry out the particular transaction (e.g., collecting payment).

Referring again to FIG. 7A, operation 710 may include operation 716 depicting generating a request to carry out at least one particular transaction with a set of two or more client devices configured to carry out the particular transaction, in response to detection of a particular event. For example, FIG. 3, e.g., FIG. 3A, shows request to carry out at least one particular transaction with a set of two or more client devices that have a particular property in common generating in response to receipt of an event indicator module 316 generating a request to carry out at least one particular transaction (e.g., collecting payment for movie theater tickets for movie goers) with a set of two or more client devices (e.g., cellular phone devices carried in the pockets of people in line at the movies, e.g., as described in previous figures) configured to carry out the particular transaction, in response to detection of a particular event (e.g., the movie will be starting in less than 60 seconds).

Referring now to FIG. 7B, operation 602 may include operation 718 depicting acquiring a request to carry out at least one particular transaction with a set of two or more client devices that have a characteristic in common, said two or more client devices configured to carry out the particular transaction. For example, FIG. 3, e.g., FIG. 3B, shows request to carry out at least one particular transaction with a set of two or more client devices that have a particular device characteristic in common acquiring module 318 acquiring a request to carry out at least one particular transaction (e.g., collecting payment for a coffee drink without the user being required to get up and wait in line) with a set of two or more client devices that have a characteristic in common (e.g., that support the store's RapidPay payment modality), said two or more client devices configured to carry out the particular transaction (e.g., paying for a coffee drink).

Referring again to FIG. 7B, operation 718 may include operation 720 depicting acquiring a request to carry out at least one particular transaction with a set of two or more client devices that are manufactured by a same manufacturer, said two or more client devices configured to carry out the particular transaction. For example, FIG. 3, e.g., FIG. 3B, shows request to carry out at least one particular transaction with a set of two or more client devices that have a common component manufacturer acquiring module 320 acquiring a request to carry out at least one particular transaction (e.g., scanning and collecting payment for a user's goods without requiring the user to wait in a checkout line) with a set of two or more client devices (e.g., smartphones, e.g., Samsung-branded smartphones) that are manufactured by a same manufacturer (e.g., Samsung is a manufacturer of smartphone devices), said two or more client devices configured to carry out the particular transaction (e.g., submitting payment for one or more goods).

Referring again to FIG. 7B, operation 718 may include operation 722 depicting acquiring a request to carry out at least one particular transaction with a set of two or more client devices that use a same operating system, said two or more client devices configured to carry out the particular transaction. For example, FIG. 3, e.g., FIG. 3B, shows request to carry out at least one particular transaction with a set of two or more client devices that have a common operating system acquiring module 332 acquiring a request to carry out at least one particular transaction (e.g., issuing authorization codes in exchange for money in a game release line) with a set of two or more client devices (e.g., smartphone devices) that use a same operating system (e.g., iOS, e.g., Apple's operating system), said two or more client devices configured to carry out the particular transaction (e.g., exchanging an authorization code for a new game).

Referring again to FIG. 7B, operation 718 may include operation 724 depicting acquiring a request to carry out at least one particular transaction with a set of two or more client devices that are executing a same program, said two or more client devices configured to carry out the particular transaction. For example, FIG. 3, e.g., FIG. 3B, shows request to carry out at least one particular transaction with a set of two or more client devices that have a particular program loaded in device memory in common acquiring module 324 acquiring a request to carry out at least one particular transaction (e.g., paying for concession items at a movie theater) with a set of two or more client devices (e.g., smartphone devices) that are executing a same program (e.g., a popcorn-pay application downloaded by the user and installed on the smartphone device, and running in the background), said two or more client devices configured to carry out the particular transaction (e.g., submitting payment for popcorn and candy, e.g., Milk Duds).

Referring again to FIG. 7B, operation 718 may include operation 726 depicting acquiring a request to carry out at least one particular transaction with a set of two or more client devices that are communicating over a particular network, said two or more client devices configured to carry out the particular transaction. For example, FIG. 3, e.g., FIG. 3B, shows request to carry out at least one particular transaction with a set of two or more client devices that are communicating using a same particular communication network acquiring module 326 acquiring a request to carry out at least one particular transaction (e.g., facilitating purchase of concert memorabilia (e.g., could be physical, e.g., t-shirts and CDs, or virtual, e.g., an MP3 of this concert when it comes out, or last week's concert in Chicago, or an MP3 album of an older album) at a Matt & Kim concert) with a set of two or more client devices (e.g., smartphone devices) that are communicating over a particular network (e.g., an AT&T provided 4G cellular network), said two or more client devices configured to carry out the particular transaction.

Referring again to FIG. 7B, operation 602 may include operation 728 depicting acquiring a request to carry out a payment receipt transaction with a set of two or more client devices configured to carry out the particular transaction. For example, FIG. 3, e.g., FIG. 3B, shows request to carry out at least one payment receipt transaction with a set of two or more client devices that have a particular property in common acquiring module 328 acquiring a request to carry out a payment receipt transaction (e.g., a notification that payment has been received) with a set of two or more client devices (e.g., tablet devices) configured to carry out the particular transaction (e.g., purchase of concessions and/or memorabilia at a hockey game).

Referring now to FIG. 7C, operation 602 may include operation 730 depicting acquiring a request to carry out an acquired item valuation transaction with a set of two or more client devices configured to carry out the acquired item valuation transaction. For example, FIG. 3, e.g., FIG. 3C, shows request to carry out at least one item valuation transaction with a set of two or more client devices that have a particular property in common acquiring module 330 acquiring a request to carry out an acquired item valuation transaction with a set of two or more client devices (e.g., vendor-provided shopping-assist devices that are similar to pricing guns) configured to carry out the

[symbol]

Referring again to FIG. 7C, operation 602 may include operation 732 depicting acquiring a request to carry out a first particular transaction with a first client device of the set of two or more client devices that is configured to carry out the first particular transaction and a request to carry out a second particular transaction with a second client device of the set of two or more client devices that is configured to carry out the second particular transaction. For example, FIG. 3, e.g., FIG. 3C, shows request to carry out at least one particular transaction with a first client device of the set of two or more client devices and to carry out at least one further transaction with a second client device of the set of two or more client devices that have a particular property in common acquiring module 332 acquiring a request to carry out a first particular transaction (e.g., purchase of Butterfinger candy and 3D glasses at a movie theater for a first user who elected to pay for the 3D glasses and grab a Butterfinger concession on the way in to the movie) with a first client device (e.g., a smartphone, e.g., an Apple iPhone) of the set of two or more client devices (e.g., a set of smartphones inside a movie theater) that is configured to carry out the first particular transaction (e.g., purchase of Butterfinger candy and 3D glasses at a movie theater for a first user who elected to pay for the 3D glasses and grab a Butterfinger concession on the way in to the movie) and a request to carry out a second particular transaction (e.g., purchase of a soda and popcorn concession from a second user) with a second client device (e.g., a smartphone, e.g., a Nokia Lumia smartphone) of the set of two or more client devices (e.g., a set of smartphones inside a movie theater) that is configured to carry out the second particular transaction (e.g., the purchase of the soda and popcorn).

Referring again to FIG. 7C, operation 602 may include operation 734 depicting acquiring a request to carry out a particular transaction with a first client device of the set of two or more client devices and to carry out the particular transaction with a second client device of the set of two or more client devices. For example, FIG. 3, e.g., FIG. 3C, shows request to carry out at least one particular transaction with a first client device of the set of two or more client devices and to carry out at least one particular transaction with a second client device of the set of two or more client devices that have a particular property in common acquiring module 334 acquiring a request to carry out a particular transaction (e.g., paying for a movie ticket to see a movie once inside the theater, e.g., you are not charged for viewing the first ten minutes of the movie) with a first client device (e.g., a smartphone device of a user sitting in row 10A of the theater) and to carry out the particular transaction (e.g., the paying for a movie ticket to see a movie once inside the theater) with a second client device (e.g., a smartphone device of the user sitting in row 20A of the theater) of the set of two or more client devices (e.g., ten smartphone devices out of all the smartphone devices in the movie theater make up the set).

Referring again to FIG. 7C, operation 602 may include operation 736 depicting detecting a set of two or more client devices that are configured to carry out the particular transaction. For example, FIG. 3, e.g., FIG. 3C, shows set of two or more devices having a particular property of being configured to carry out the particular transaction in common detecting module 336 detecting a set of two or more client devices (e.g., tablet devices) that are configured to carry out the particular transaction (e.g., are authorized by a user to release payment information to the particular vendor involved in the potential transaction).

Referring again to FIG. 7C, operation 602 may include operation 738 depicting acquiring a request to carry out the at least one particular transaction with at least two of the detected set of two or more client devices. For example, FIG. 3, e.g., FIG. 3C, shows request to carry out the at least one the particular transaction with at least two of the detected set of two or more client devices module 338 acquiring a request to carry out the at least one particular transaction (e.g., paying for drinks at a bar) with at least two of the detected set of two or more client devices (e.g., tablet devices authorized by a user to release payment information to the particular vendor involved in the potential transaction).

Referring again to FIG. 7C, operation 736 may include operation 740 depicting detecting a set of two or more client devices that meet a particular criterion. For example, FIG. 3, e.g., FIG. 3C, shows set of two or more client devices having the particular property of being configured to carry out the particular transaction in common and that meet a particular criteria detecting module 340 detecting a set of two or more client devices (e.g., laptop devices) that meet a particular criteria (e.g., are manufactured by Dell, or have a USB 3.0 slot, e.g., the criterion does not need to be connected to the transaction, although it may be).

Referring again to FIG. 7C, operation 740 may include operation 742 depicting detecting a set of two or more client devices that are associated with two or more clients that have a particular customer profile. For example, FIG. 3, e.g., FIG. 3C, shows set of two or more client devices having the particular property of being configured to carry out the particular transaction in common and that are associated with respective clients having a particular customer profile detecting module 342 detecting a set of two or more client devices (e.g., tablet devices) that are associated with two or more clients (e.g., two discrete tablets are associated with two different users) that have a particular customer profile (e.g., the two different users have each purchased science fiction books before, or the two different users each have a credit score above 750, or the two different users each have a Discover-brand credit card).

It is noted that “indicator” and “indication” can refer to many different things, including any of electronic signals (e.g., pulses between two components), human-understandable signals (e.g., information being displayed on a screen, or a lighting of a light, or a playing of a sound), and non-machine related signals (e.g., two people talking, a change in ambient temperature, the occurrence of an event, whether large scale (e.g., earthquake) or small-scale (e.g., the time becomes 4:09 p.m. and 32 seconds), alone or in any combination.

FIGS. 8A-8C depict various implementations of operation 604, depicting adapting at least one vendor payment channel of a vendor payment channel set for use with a first client payment channel acquired from a first device of the set of two or more client devices, to facilitate at least a portion of a particular transaction with the first device, wherein the first client payment channel is absent from the vendor payment channel set, according to embodiments. Referring now to FIG. 8A, operation 604 may include operation 802 depicting carrying out one or more actions that allow the first client payment channel to be used for a first portion of the particular transaction and the particular vendor payment channel to be used for a second portion of the particular transaction. For example, FIG. 4, e.g., FIG. 4A, shows vendor payment channel from vendor payment channel set interfacing with an acquired first user payment channel associated with a first device of the set of two or more client devices in order to facilitate at least a portion of the particular transaction module 402 carrying out one or more actions (e.g., data acquisition, e.g., acquiring a conversion table, resource location, resource allocation, contacting an intermediate device, contacting a remote server, receiving a payment agreement from a third party, finding another device to perform a part of the transaction) that allow the first client payment channel (e.g., credit card verification with swipe only) to be used for a first portion of the particular transaction (e.g., the portion in which the user submits the payment information) and the particular vendor payment channel (e.g., a payment modality of credit card verification with billing zip code) to be used for a second portion of the particular transaction (e.g., the portion in which the vendor receives and/or processes the payment information.

Referring again to FIG. 8A, operation 604 may include operation 804 depicting carrying out one or more actions that allow the first client payment channel to be used for a first portion of the particular transaction and the particular vendor payment channel to be used for a second portion of the particular transaction. For example, FIG. 4, e.g., FIG. 4A, shows one or more actions that allow use of the first user payment channel for a first portion of the particular transaction and use of the vendor payment channel for a second portion of the particular transaction executing module 404 carrying out one or more actions (e.g., locating an intermediary device that is configured to accept the first client payment channel and the vendor payment channel) that allow the first client payment channel (e.g., one-dimensional bar code reading as a payment modality) to be used for a first portion of the particular transaction (e.g., a portion of the particular transaction in which the client is interacted with) and the vendor payment channel (e.g., color bar code reading as a vendor payment modality) to be used for a second portion of the particular transaction (e.g., a portion of the particular transaction in which the vendor is interacted with).

Referring again to FIG. 8A, operation 804 may include operation 806 depicting receiving data using the first client payment channel as the first portion of the particular transaction. For example, FIG. 4, e.g., FIG. 4A, shows use of the first client payment channel for the first portion of the particular transaction data receiving module 406 receiving data (e.g., a credit card number and a scan of a document executed by the user) as the first portion of the particular transaction.

Referring again to FIG. 8A, operation 804 may include operation 808 depicting adapting the received data for use with the vendor payment channel as the second portion of the particular transaction. For example, FIG. 4, e.g., FIG. 4A, shows received data adapting for use with the vendor payment channel as the second portion of the particular transaction module 408 adapting (e.g., converting the scan of the executed document into an image file of the user's signature) the received data (e.g., the credit card number and the scan of the document executed by the user) for use with the vendor payment channel (e.g., credit card verification with signature) as the second portion of the particular transaction.

Referring again to FIG. 8A, operation 802 may include operation 810 depicting carrying out a portion of the particular transaction with the first device using the first client payment channel. For example, FIG. 4, e.g., FIG. 4A, shows portion of the particular transaction using the first device executing using the first client payment channel module 410 carrying out a portion of the particular transaction (e.g., paying for airline tickets in the airplane) with the first device (e.g., a user's smartphone) using the first client payment channel (e.g., paying with travelers' checks).

Referring again to FIG. 8A, operation 802 may include operation 812 depicting converting a result of the carrying out the first portion of the particular transaction using the first client payment channel into a format acceptable for use with the vendor payment channel. For example, FIG. 4, e.g., FIG. 4A, shows result of executing the portion of the particular transaction using the first device converting for use with the vendor payment channel module 412 converting a result of the carrying out the first portion of the particular transaction (e.g., scanning the executed travelers' checks) using the first client payment channel into a format acceptable for use (e.g., using the scanned data to contact a provider of the executed travelers' checks to verify their authenticity, then using the device to confirm the user's identity, then receiving an agreement to provide payment from the provider of the executed travelers' checks, who then cancels the executed travelers' checks and provides the vendor with payment) with the vendor payment channel (e.g., cash equivalents).

Referring now to FIG. 8B, operation 604 may include operation 814 depicting providing one or more instructions to the first device for adapting the first client payment channel for use with the at least one vendor payment channel. For example, FIG. 4, e.g., FIG. 4B, shows instruction for adapting the first client payment channel for use with the vendor payment channel providing to the first client device module 414 providing one or more instructions to the first device for adapting the first client payment channel (e.g., device authentication using cellular network as a payment modality) for use with the at least one vendor payment channel (e.g., device authentication using wireless network as a payment modality).

Referring again to FIG. 8B, operation 604 may include operation 816 depicting determining a resource configured to be used to allow the at least one vendor payment channel to be used with the first client payment channel. For example, FIG. 4, e.g., FIG. 4B, shows resource configured to be used to allow the vendor payment channel to be used with the first client payment channel obtaining module 416 determining a resource (e.g., a BitCoin exchange provider that accepts American Express-branded credit cards) configured to be used to allow the at least one vendor payment channel (e.g., BitCoin exchange) to be used with the first client payment channel (e.g., American Express card as a payment option).

Referring again to FIG. 8B, operation 604 may include operation 818 depicting accepting, using the determined resource, the first client payment channel acquired from the first device of the set of two or more client devices. For example, FIG. 4, e.g., FIG. 4B, shows first client payment channel associated with the first device accepting using the obtained resource module 418 accepting, using the determined resource (e.g., the BitCoin exchange provider that accepts American Express-branded credit cards), the first client payment channel (e.g., American Express card as a payment option) acquired from the first device (e.g., a user's smartphone device) of the set of two or more client devices.

Referring again to FIG. 8B, operation 816 may include operation 820 depicting determining a database configured to be used to allow the at least one vendor payment channel to be used with the first client payment channel. For example, FIG. 4, e.g., FIG. 4B, shows data stored in a database configured to be used to allow the vendor payment channel to be used with the first client payment channel obtaining module 420 determining a database (e.g., a conversion rate database), e.g., which may be stored in payment data conversion tables 226A of FIG. 2B, for example, configured to be used to allow the at least one vendor payment channel (e.g., accepting euro currency as a payment option) to be used with the first client payment channel (e.g., accepting United States currency as a payment option).

Referring again to FIG. 8B, operation 820 may include operation 822 depicting determining a database that is configured to allow translation of one or more nonspecific codes identifying one or more items to which the client device has access to one or more vendor-specific codes for use with the vendor payment channel. For example, FIG. 4, e.g., FIG. 4B, shows data stored in a vendor-specific code translation database configured to be used to allow the vendor payment channel to be used with the first client payment channel obtaining module 422 determining a database (e.g., a database stored in device memory 226 of device 208 as shown in FIG. 2B that is configured to allow translation of one or more nonspecific codes identifying one or more items to which the client device has access (e.g., one or more food items in a user's smart shopping cart) to one or more vendor-specific codes for use with the vendor payment channel (e.g., recognizing vendor-specific two-dimensional bar codes).

Referring again to FIG. 8B, operation 816 may include operation 824 depicting determining an arbitraging resource configured to be used to process the first client payment channel. For example, FIG. 4, e.g., FIG. 4B, shows arbitraging resource configured to be used to allow the vendor payment channel to be used with the first client payment channel obtaining module 424 determining an arbitraging resource (e.g., a mercantile exchange) configured to be used to process the first client payment channel (e.g., foreign currency).

Referring again to FIG. 8B, operation 824 may include operation 826 depicting determining an arbitraging resource that is configured to use both of the first client payment channel and the vendor payment channel, and configured to accept payment from the first device using the first client payment channel, and configured to provide payment using the vendor payment channel. For example, FIG. 4, e.g., FIG. 4B, shows arbitraging resource configured to be used to allow the vendor payment channel to be used with the first client payment channel by accepting payment using the first client payment channel and submitting payment using the vendor payment channel obtaining module 426 determining an arbitraging resource (e.g., an intermediary bank, e.g., “Bank I” that is configured to use both of the first client payment channel (e.g., debiting bank account at “Bank A”) and the vendor payment channel (e.g., using a bank account at “Bank B”), and configured to accept payment from the first device using the first client payment channel (e.g., debiting “Bank A” into “Bank I's” accounts) and configured to provide payment (e.g., depositing funds into “Bank B's” account from Bank I) using the vendor payment channel.

Referring now to FIG. 8C, operation 604 may include operation 828 depicting determining one or more external device resources configured to facilitate at least a portion of the particular transaction with the first device. For example, FIG. 4, e.g., FIG. 4C, shows external device resource configured to be used to facilitate at least a portion of the particular transaction with the first device obtaining module 428 determining one or more external device resources (e.g., an instant credit provider) configured to facilitate at least a portion of the particular transaction (e.g., purchasing electronics at a big-box electronics store).

Referring again to FIG. 8C, operation 604 may include operation 830 depicting transmitting data regarding the one or more determined resources to the first device configured to use the first client payment channel. For example, FIG. 4, e.g., FIG. 4C, shows data regarding the obtained information regarding the external device resource to the first device configured to use the first client payment channel transmitting module 430 transmitting data regarding the one or more determined resources (e.g., an address and data submission requirements of the instant credit provider) to the first device (e.g., a user's laptop computer) configured to use the first client payment channel (e.g., an electronic funds transfer from Bank Gamma).

Referring again to FIG. 8C, operation 828 may include operation 832 depicting determining one or more external device resources configured to be used to carry out a first portion of the particular transaction with the first device using the first client payment channel and to carry out a second portion of the particular transaction using the vendor payment channel, For example, FIG. 4, e.g., FIG. 4C, shows external device resource configured to be used to facilitate at least a portion of the particular transaction with the first device by using the first client payment channel and to facilitate another portion of the particular transaction using the vendor payment channel information obtaining module 432 determining one or more external device resources (e.g., an online purchases store, e.g., the Apple-branded “App Store”) configured to be used to carry out a first portion of the particular transaction (e.g., paying for a skirt at a department store) with the first device (e.g., an Apple tablet device) using the first client payment channel (e.g., credit in Apple's store) and to carry out a second portion of the particular transaction (e.g., compensating the department store for the skirt) using the vendor payment channel (e.g., electronic funds transfer from a bank account as a payment option).

Referring again to FIG. 8C, operation 832 may include operation 834 depicting determining one or more external devices that are configured to use both the first client payment channel and the vendor payment channel. For example, FIG. 4, e.g., FIG. 4C, shows external device resource configured to use the first client payment channel and configured to use the vendor payment channel information obtaining module 434 determining one or more external devices (e.g., smartphone devices, laptops, tablet devices, etc.) that are configured to use both of the first client payment channel (e.g., BitCoins as a payment option) and the vendor payment channel (e.g., device tap with near-field communication as a payment modality).

Referring again to FIG. 8C, operation 834 may include operation 836 depicting selecting an external device from a list of one or more external devices that are configured to use both of the first client payment channel and the vendor payment channel. For example, FIG. 4, e.g., FIG. 4C, shows external device resource configured to use the first client payment channel and configured to use the vendor payment channel selecting from a list of external device resources module 436 selecting an external device (e.g., a smartphone carried by another user) from a list of one or more external devices (e.g., three smartphones located in the vicinity of the grocery store) that are configured to use both of the first client payment channel (e.g., a payment option of credit card omega and a payment modality of credit card swipe+signature) and the vendor payment channel (e.g., a payment option of credit card delta and a payment modality of credit card+PIN entry).

Referring again to FIG. 8C, operation 836 may include operation 838 depicting selecting an external device from a list of one or more external devices that are configured to use both of the first client payment channel and the vendor payment channel, said list received from a device component manufacturer. For example, FIG. 4, e.g., FIG. 4C, shows external device resource configured to use the first client payment channel and configured to use the vendor payment channel selecting from a list of external device resources provided by a first device component manufacturer module 438 selecting an external device from a list of one or more external devices (e.g., Samsung-branded smartphones and tablets) that are configured to use both of the first client payment channel (e.g., 256-bit encrypted wireless network communication as a payment modality) and the vendor payment channel (e.g., near field communication as a payment modality), said list received from a device component manufacturer (e.g., Samsung, e.g., has a list of Samsung-branded devices).

Referring again to FIG. 8C, operation 836 may include operation 840 depicting selecting an external device from a list of one or more external devices that are configured to use both of the first client payment channel and the vendor payment channel, said list received from a device application designer. For example, FIG. 4 e.g., FIG. 4C, shows external device resource configured to use the first client payment channel and configured to use the vendor payment channel selecting from a list of external device resources provided by a first device application designer module 440 selecting an external device (e.g., a smartphone device running Windows Phone 8 operating system) from a list of one or more external devices that are configured to use both of the first client payment channel (e.g., 256-bit encrypted wireless network communication as a payment modality) and the vendor payment channel (e.g., near field communication as a payment modality), said list received from a device application designer (e.g., Microsoft, e.g., who designs operating systems and/or applications for Windows Phone 8).

Referring again to FIG. 8C, operation 832 may include operation 842 depicting selecting an external device from a generated list of one or more external devices that are configured to use both of the first client payment channel and the vendor payment channel. For example, FIG. 4, e.g., FIG. 4C, shows external device resource configured to use the first client payment channel and configured to use the vendor payment channel selecting from a generated list of external device resources module 442 selecting an external device from a generated list (e.g., created by analyzing data transmitted across the free wireless network provided at a coffee shop) of one or more external devices (e.g., capable devices that are connected to a network and located inside a coffee shop) that are configured to use both of the first client payment channel (e.g., numbered traveler's checks as a payment option) and the vendor payment channel (e.g., credit card beta as a payment option).

Referring now to FIG. 8D, operation 828 may include operation 844 depicting polling at least one device to determine one or more external device configured to facilitate at least a portion of the particular transaction with the first device. For example, FIG. 4, e.g., FIG. 4D, shows external device resource configured to be used to facilitate at least a portion of the particular transaction with the first device information obtaining by polling at least one device module 444 polling (e.g., using an external resource contacting module, e.g., external resource contacting module 285A) at least one device to determine one or more external devices configured to facilitate at least a portion of the particular transaction (e.g., paying for train tickets) with the first device (e.g., a user's laptop computer).

Referring again to FIG. 8D, operation 844 may include operation 846 depicting polling the set of two or more client devices to determine one or more external device configured to facilitate at least a portion of the particular transaction with the first device. For example, FIG. 4, e.g., FIG. 4D, shows external device resource configured to be used to facilitate at least a portion of the particular transaction with the first device information obtaining by polling the set of two or more client devices module 446 polling the set of two or more client devices (e.g., the devices that are submitting payment for seeing the movie) to determine one or more external device (e.g., an external device may be part of the set of two or more client devices, in some embodiments) configured to facilitate at least a portion of the particular transaction (e.g., paying for concessions at a movie theater) with the first device (e.g., a user sitting in Seat 20A with popcorn and a soda, and a smartphone).

Referring again to FIG. 8D, operation 844 may include operation 848 depicting polling at least one device having a particular characteristic to determine one or more external devices configured to facilitate at least a portion of the particular transaction with the first device. For example, FIG. 4, e.g., FIG. 4D, shows external device resource configured to be used to facilitate at least a portion of the particular transaction with the first device information obtaining by polling at least one device having a particular property module 448 polling at least one device having a particular characteristic (e.g., devices that support near-field communication) to determine one or more external devices configured to facilitate at least a portion of the particular transaction with the first device (e.g., a device that wants to pay for the user's coffee drink, but does not have near field communication and does not want to require the user to have to wait in line at the register to directly slide her credit card).

Referring again to FIG. 8D, operation 848 may include operation 850 depicting polling at least one device within a particular proximity to a particular location, to determine one or more external devices configured to facilitate at least a portion of the particular transaction with the first device. For example, FIG. 4, e.g., FIG. 4D, shows external device resource configured to be used to facilitate at least a portion of the particular transaction with the first device information obtaining by polling at least one device at a particular location module 450 polling at least one device (e.g., a tablet device) within a particular proximity to a particular location (e.g., a payment station for a vendor of coffee drinks), to determine one or more external devices (e.g., one or more tablet devices) configured to facilitate at least a portion of the particular transaction (e.g., by accepting a first client payment channel (e.g., online bank account, e.g., PayPal, transaction as a payment option) and a vendor payment channel (e.g., direct debiting of a bank account as a payment option)) with the first device (e.g., a user's tablet device).

Referring again to FIG. 8D, operation 850 may include operation 852 depicting polling at least one device within a particular proximity to the first device, to determine one or more external devices configured to facilitate at least a portion of the particular transaction with the first device. For example, FIG. 4, e.g., FIG. 4D, shows external device resource configured to be used to facilitate at least a portion of the particular transaction with the first device information obtaining by polling at least one device near a first device location module 452 polling at least one device within a particular proximity to the first device, to determine one or more external devices configured to facilitate at least a portion of the particular transaction (e.g., purchasing groceries at the grocery store) with the first device (e.g., a user's smartphone)

Referring again to FIG. 8D, operation 848 may include operation 854 depicting polling at least one device communicating over a particular communication network, to determine one or more external devices configured to facilitate at least a portion of the particular transaction with the first device. For example, FIG. 4, e.g., FIG. 4D, shows external device resource configured to be used to facilitate at least a portion of the particular transaction with the first device information obtaining by polling at least one device communicating via a particular communication network module 454 polling at least one device communicating over a particular communication network (e.g., an AT&T EDGE-branded cellular network), to determine one or more external devices configured to facilitate at least a portion of the particular transaction with the first device (e.g., an AT&T-based smartphone, e.g., a Nokia Lumia).

Referring now to FIG. 8E, operation 848 may include operation 856 depicting polling at least one device manufactured by a particular manufacturer, to determine one or more external devices configured to facilitate at least a portion of the particular transaction with the first device. For example, FIG. 4, e.g., FIG. 4E, shows external device resource configured to be used to facilitate at least a portion of the particular transaction with the first device information obtaining by polling at least one device manufactured by a particular manufacturer module 456 polling at least one device (e.g., a tablet device) manufactured by a particular manufacturer (e.g., Samsung), to determine one or more external devices configured to facilitate at least a portion of the particular transaction (e.g., paying for a coffee drink at a coffee shop) with the first device (e.g., a tablet device).

Referring again to FIG. 8E, operation 848 may include operation 858 depicting polling at least one device that has a particular application active, to determine one or more external devices configured to facilitate at least a portion of the particular transaction with the first device. For example, FIG. 4, e.g., FIG. 4E, shows external device resource configured to be used to facilitate at least a portion of the particular transaction with the first device information obtaining by polling at least one device that is configured to execute a particular application module 458 polling at least one device (e.g., a laptop device) that has a particular application (e.g., a banking application) active, to determine one or more external devices (e.g., various laptops connected to one or more networks) configured to facilitate at least a portion of the particular transaction (e.g., purchasing a new electronics device at a specialized store, e.g., an Apple-branded store) with the first device (e.g., a cellular device in the store).

Referring again to FIG. 8E, operation 828 may include operation 860 depicting selecting an external device from the set of two or more client devices, said external device configured to use both of the first client payment channel and the vendor payment channel. For example, FIG. 4, e.g., FIG. 4E, shows external device resource configured to use the first client payment channel and configured to use the vendor payment channel information obtaining module 460 selecting an external device from the set of two or more client devices, said external device configured to accept both of the first client payment channel (e.g., bank debit card gamma as a payment option) and the vendor payment channel (e.g., Apple-branded account points or credits accepting as a payment option).

Referring again to FIG. 8E, operation 828 may include operation 862 depicting selecting the second device as the external device, said second device configured to use both of the first client payment channel and the vendor payment channel. For example, FIG. 4, e.g., FIG. 4E, shows second device as the external device resource configured to be used to facilitate at least a portion of the particular transaction with the first device selecting module 462 selecting the second device (e.g., a smartphone device in a different part of a subway train) as the external device, said second device configured to use both of the first client payment channel (e.g., numbered traveler's checks as a payment option) and the vendor payment channel (e.g., credit card beta as a payment option).

Referring now to FIG. 8F, operation 604 may include operation 864 depicting determining a resource that is configured to facilitate at least a portion of the particular transaction using the first client payment channel. For example, FIG. 4, e.g., FIG. 4F, shows resource configured to be used to link the vendor payment channel with the first client payment channel obtaining module 464 determining a resource (e.g., an intermediary device that sits on the vendor's counter and uses a new form of device communication called “Green Lightning” (e.g., this is hypothetical, no such protocol exists at the time of filing, and any similarity between this hypothetical protocol and a real protocol is strictly coincidental) that a particular vendor is distributing in order to try to get the device protocol adopted by more devices) that is configured to facilitate at least a portion of the potential transaction (e.g., paying for ice cream at an ice cream store) using the first client payment channel (e.g., the user wants to use “Green Lightning” as a payment modality due to its increased security and identity verification features).

Referring again to FIG. 8F, operation 604 may include operation 866 depicting requesting assistance from the determined resource in facilitating the particular transaction. For example, FIG. 4, e.g., FIG. 4F, shows assistance from the determined resource in facilitating the particular transaction requesting module 466 requesting assistance from the determined resource (e.g., the intermediary device described above with “Green Lightning” functionality) in facilitating the particular transaction (e.g., paying for an ice cream at the ice cream store).

Referring again to FIG. 8F, operation 864 may include operation 868 depicting determining a resource that is configured to facilitate at least a portion of the particular transaction using the first client payment channel, at least partly based on the first client payment channel. For example, FIG. 4, e.g., FIG. 4F, shows resource configured to be used to link the vendor payment channel with the first client payment channel obtaining at least partly based on the first client payment channel module 468 determining a resource (e.g., an intermediary device owned by a different user that has a relationship to the user carrying out the transaction) that is configured to facilitate at least a portion of the potential transaction (e.g., paying for a video game at a video game store) using the acquired payment channel (e.g., device verification for family-shared account debiting), at least partly based on the first client payment channel (e.g., the acquired payment modality, e.g., “find my trusted device that stores the actual payment information,” allows the vendor to find a trusted device, e.g., owned by a child's mother, and verifying the purchase and obtaining the credit card information from the mother, thus the child can use her device to pick out a video game, and it can be authorized by the mother, who has access to a credit card account and who wants to keep tabs on her child's spending).

Referring again to FIG. 8F, operation 868 may include operation 870 depicting determining a resource that is configured to facilitate at least a portion of the particular transaction using the first client payment channel, including a first client payment option, at least partly based on the first client payment option. For example, FIG. 4, e.g., FIG. 4F, shows resource configured to be used to link the vendor payment channel with the first client payment channel obtaining at least partly based on the first client payment channel that includes a first client payment option module 470 determining a resource (e.g., a points auction network, e.g., where shopping points accrued at a particular store (e.g., a cooking utensil store) can be traded for points from a different store, e.g., the store that the user is currently in, e.g., a camping store) that is configured to facilitate at least a portion of the particular transaction (e.g., purchasing a tent from the camping store), including a first client payment option (e.g., points from a cooking utensil store), at least partly based on the first client payment option (e.g., an exchange is located that participates in exchange of points from the cooking utensil store).

Referring again to FIG. 8F, operation 870 may include operation 872 depicting determining a resource that is a provider of at least one aspect of the first client payment option, said resource configured to facilitate at least a portion of the particular transaction. For example, FIG. 4, e.g., FIG. 4F, shows resource that is a facilitator of the first client payment option and is configured to be used to link the vendor payment channel with the first client payment channel obtaining at least partly based on the first client payment channel that includes the first client payment option module 472 determining a resource (e.g., a credit card company server) that is a provider of at least one aspect of the first client payment option (e.g., the credit card “gamma”), said resource configured to facilitate at least a portion of the particular transaction (e.g., paying for a coffee drink).

Referring again to FIG. 8F, operation 866 may include operation 874 depicting requesting that the determined resource contact the first device to facilitate a portion of the particular transaction using the first client payment channel. For example, FIG. 4, e.g., FIG. 4F, shows initiation of contact with the first device requesting from the determined resource in facilitating the particular transaction module 474 requesting that the determined resource (e.g., the credit card company server) contact the first device (e.g., the user's motor vehicle control/accessory system) to facilitate a portion of the particular transaction (e.g., submitting payment for gasoline) using the first client payment channel (e.g., a payment modality of credit card swipe and billing zip code).

Referring now to FIG. 8G, operation 604 may include operation 876 depicting selecting an intermediary device having a particular characteristic, said intermediary device configured to facilitate at least a portion of the particular transaction. For example, FIG. 4, e.g., FIG. 4G, shows intermediary device having a particular property and configured to facilitate at least a portion of the particular transaction selecting module 476 selecting an intermediary device having a particular characteristic (e.g., the intermediary device is manufactured by Samsung), said intermediary device configured to facilitate at least a portion of the potential transaction (e.g., purchasing concessions from a seat at a baseball game).

Referring again to FIG. 8G, operation 604 may include operation 878 depicting negotiating an agreement with the intermediary device to facilitate at least a portion of the particular transaction. For example, FIG. 4, e.g., FIG. 4G, shows agreement to facilitate at least a portion of the particular transaction negotiating with the intermediary device module 478 negotiating (e.g., providing one or more parameters for, whether formally (e.g., contract) or informally) an agreement with the intermediary device (e.g., an external user device belonging to a user unrelated to the user involved in the transaction) to facilitate at least a portion of the potential transaction (e.g., to accept payment data from a user device using a payment channel that is not directly accepted, and to provide payment data to the vendor using a payment channel that is directly accepted).

Referring again to FIG. 8G, operation 604 may include operation 880 depicting transmitting data regarding the intermediary device to the first device. For example, FIG. 4, e.g., FIG. 4G, shows intermediary device-related data transmitting to the first device module 480 transmitting data (e.g., location data, or authentication data) regarding the intermediary device (e.g., the external user device belonging to a user unrelated to the user involved in the transaction) to a user device that has requested to use the payment channel (e.g., a payment option of credit card gamma).

Referring again to FIG. 8G, operation 876 may include operation 882 depicting selecting the second device of the set of two or more client devices as the intermediary device. For example, FIG. 4, e.g., FIG. 4G, shows second device as intermediary device selecting module 482 selecting the second device (e.g., a smartphone of a person located in a same store and who is next in line, for example) of the set of two or more client devices as the intermediate device.

Referring again to FIG. 8G, operation 876 may include operation 884 depicting selecting an intermediary device from the set of two or more client devices. For example, FIG. 4, e.g., FIG. 4G, shows intermediary device having a particular property and configured to facilitate at least a portion of the particular transaction selecting from the set of two or more client devices module 484 selecting an intermediary device (e.g., external user device belonging to a user unrelated to the user involved in the transaction) from the set of two or more client devices (e.g., a set that includes two devices, and may include more devices, but does not necessarily include all devices, and the devices may have some logical connection, or may be completely unrelated).

Referring again to FIG. 8G, operation 876 may include operation 886 depicting selecting an intermediary device configured to use the first client payment channel and configured to use the vendor payment channel. For example, FIG. 4, e.g., FIG. 4G, shows intermediary device configured to conduct one or more transactions using the first client payment channel and configured to conduct one or more transactions using the vendor payment channel selecting module 486 selecting an intermediary device (e.g., a different user's device) configured to use the first client payment channel (e.g., a payment modality of near-field communication) and configured to use the vendor payment channel (e.g., a payment modality of reading a bar code).

Referring again to FIG. 8G, operation 876 may include operation 888 depicting selecting an intermediary device that is configured to run a particular operating system, said intermediary device configured to facilitate at least a portion of the particular transaction. For example, FIG. 4, e.g., FIG. 4G, shows intermediary device configured to execute a particular program and configured to facilitate at least a portion of the particular transaction selecting module 488 selecting an intermediary device that is configured to run a particular operating system (e.g., Android operating system, or iOS, or Windows Phone operating system), said intermediary device configured to facilitate at least a portion of the potential transaction (e.g., purchasing groceries from a grocery store).

Referring again to FIG. 8G, operation 878 may include operation 890 depicting agreeing to provide the intermediary device with compensation in return for facilitating at least a portion of the particular transaction. For example, FIG. 4, e.g., FIG. 4G, shows agreement to facilitate compensation to the intermediary device for facilitating a portion of the particular transaction negotiating module 490 agreeing (e.g., providing assent, which in some embodiments may be done electronically or without human intervention) to provide the intermediary device with compensation in return for facilitating at least a portion of the potential transaction.

Referring again to FIG. 8G, operation 880 may include operation 892 depicting transmitting an address of the intermediary device to the first device. For example, FIG. 4, e.g., FIG. 4G, shows intermediary location and/or addressing data transmitting to the first device module 492 transmitting an address (e.g., an IP address) of the intermediary device (e.g., a tablet held by another user in the same coffee shop as the user involved in the potential transaction) to the first device (e.g., a laptop device of a laptop sitting in a coffee shop).

Referring again to FIG. 8G, operation 880 may include operation 894 depicting transmitting a verification code used by the intermediary device to the first device that has requested to use the first client payment channel, said verification code configured to be used to verify an identity of the intermediary device. For example, FIG. 4, e.g., FIG. 4G, shows intermediary device recognition code data transmitting to the first device module 494 transmitting a verification code (e.g., a passcode that is given only to the intermediary device, so that the intermediary device can verify itself to the user's device prior to accepting the user's personal information from the device) to the first device (e.g., the user's smartphone) that has requested to use the first client payment channel, said verification code configured to be used to verify an identity of the intermediary device (e.g., to verify that “this is the authentic device that's going to help complete the transaction,” and, in an embodiment, may, but is not required to, specifically identify the intermediary device (e.g., in some embodiments, it may be better to keep the device anonymous).

Referring now to FIG. 8H, operation 880 may include operation 896 depicting carrying out the particular transaction using the vendor payment channel of the vendor payment channel set in a manner which is configured to allow the first device of the set of two or more client devices to appear to use the first client payment channel. For example, FIG. 4, e.g., FIG. 4G, shows transaction using vendor payment channel from vendor payment channel set facilitating at least a portion of the particular transaction such that the first client device is allowed to appear to use the first client payment channel module 496 carrying out the particular transaction (e.g., paying for a coffee drink at a coffee shop) using the vendor payment channel (e.g., using electronic funds transfer for bank Gamma) of the vendor payment channel set in a manner which is configured to allow the first device (e.g., a smartphone device) of the set of two or more client devices to appear to use the first client payment channel (e.g., the “allow to appear” in this example merely means that the first device debits the first client payment channel, e.g., credit card alpha, and then uses a relationship, e.g., through an external resource, to submit payment using bank Gamma, without further notification to the user. To the user, it makes no difference whether bank Gamma was used as an intermediate step, since the user is only informed of the debiting of the credit card alpha.

Referring again to FIG. 8H, operation 896 may include operation 898 depicting carrying out the particular transaction using the vendor payment channel in a manner which is configured to allow the first device of the set of two or more client devices to appear, to a user of the first device, to use the first client payment channel. For example, FIG. 4, e.g., FIG. 4H, shows transaction using vendor payment channel from vendor payment channel set facilitating at least a portion of the particular transaction such that the first client device is allowed to appear to use the first client payment channel to a user of the first device module 498 carrying out the particular transaction using the vendor payment channel (e.g., near field communication as a payment modality) in a manner which is configured to allow the first device (e.g., a user's laptop device sitting in a cafe) of the set of two or more client devices to appear, to a user of the first device, to use the first client payment channel (e.g., the first client payment channel is “credit card data transmitted over a wireless network that is encrypted,” and the transaction is carried out by locating an external resource that receives the credit card data over the encrypted wireless network from the first device, and then relays the data to the vendor using near-field communication, and the relay of the data takes place transparently to the user, who from her perspective, used the wireless network to transmit the data to the vendor, and does not have details about the intermediary).

Referring again to FIG. 8H, operation 896 may include operation 801 depicting instructing the first device to obtain transaction data at least partly using the first client payment channel. For example, FIG. 4, e.g., FIG. 4H, shows instruction for first device to obtain transaction data at least partly using the first client payment channel providing module 401 instructing the first device to obtain transaction data (e.g., payment data, e.g., credit card number) at least partly using the first client payment channel (e.g., credit card number only verification)

Referring again to FIG. 8H, operation 896 may include operation 803 depicting instructing the first device to convert the transaction data into a format configured to be used with the vendor payment channel. For example, FIG. 4, e.g., FIG. 4H, shows instruction for first device to manipulate the transaction data into a format configured to be used with the vendor payment channel providing module 403 instructing the first device to convert the transaction data (e.g., the credit card number only) into a format configured to be used with the vendor payment channel (e.g., instructing the first device to retrieve the billing zip code from an online statement provided by the credit card company that the user has access to, e.g., by providing the first device with the address of the credit card company that the user device can access).

Referring again to FIG. 8H, operation 896 may include operation 805 depicting facilitating the particular transaction with the first device using the vendor payment channel. For example, FIG. 4, e.g., FIG. 4H, shows instruction for facilitating the particular transaction using the vendor payment channel providing module 405 facilitating the particular transaction (e.g., paying for gasoline at a gas station) with the first device (e.g., a motor vehicle navigation (with additional functionality) system mounted in a motor vehicle) using the vendor payment channel (e.g., credit card number and billing zip code verification).

Referring again to FIG. 8H, operation 801 may include operation 807 depicting instructing the first device to obtain transaction data using the first client payment channel, in order to appear to a user of the first device that the first client payment channel is used to carry out the particular transaction. For example, FIG. 4, e.g., FIG. 4H, shows instruction for first device to obtain transaction data in order to appear to a user of the first client device that the first client payment channel is used providing module 407 instructing the first device to obtain transaction data using the first client payment channel (e.g., obtaining a user's bank account access code from the user device), in order to appear to a user of the first device (e.g., a smartphone) that the first client payment channel (e.g., entry of a bank account authorization code as a payment modality) is used to carry out the particular transaction (e.g., paying for dinner at a fancy restaurant).

Referring again to FIG. 8H, operation 803 may include operation 809 depicting providing the first device with one or more resources for converting the payment data into a format configured to be used with the vendor payment channel. For example, FIG. 4, e.g., FIG. 4H, shows one or more resources configured to assist in manipulation of the transaction data into a format configured to be used with the vendor payment channel providing module 409 providing the first device with one or more resources (e.g., databases, access to credit card company records, credit rating bureaus, and the like) for converting the payment data (e.g., access to a first bank account) into a format configured to be used with the vendor payment channel (e.g., using a second bank account as a payment option, and an intermediary arbitrage with relationships to the first bank and the second bank to perform the conversion of first bank resources into second bank resources).

Referring again to FIG. 8H, operation 805 may include operation 811 depicting facilitating the particular transaction with the first device using the vendor payment channel, said facilitating occurring without notification of the use of the vendor payment channel to the user of the first device. For example, FIG. 4, e.g., FIG. 4H, shows instruction for facilitating the particular transaction using the vendor payment channel without providing direct notification to the user providing module 411 facilitating the particular transaction (e.g., paying for a coffee drink at a coffee shop) with the first device (e.g., a user's laptop device) using the vendor payment channel (e.g., credit card verification with signature), said facilitating occurring without notification of the user of the vendor payment channel (e.g., credit card verification with signature) to the user of the first device (e.g., the user of the laptop is not notified that her image file of her signature was transmitted to the vendor for authorization to pay for her coffee drink; to her it simply looks like “credit card authorization” with no other step was used as a payment modality).

FIGS. 9A-9Q depict various implementations of operation 606 depicting adapting at least one vendor payment channel of the vendor payment channel set for use with a second client payment channel acquired from a second device of the set of two or more client devices, to facilitate at least a portion of a further transaction with the second device, wherein the second client payment channel is different than the first client payment channel, according to embodiments. Referring now to FIG. 9A, operation 606 may include operation 902 depicting adapting one or more of a vendor payment option and a vendor payment modality for use with a second client payment channel including one or more of a second client payment option and a second client payment modality acquired from the second device of the set of two or more client devices, to facilitate at least a portion of the further transaction, wherein at least one of the second client payment option and the second client payment modality is different than at least one of a first client payment option and a first client payment modality of the first client payment channel. For example, FIG. 5, e.g., FIG. 5A, shows vendor payment channel from vendor payment channel set adapting for use with an acquired second client payment channel including at least one of a second client payment option and a second client payment modality that is different than the first client payment channel including a first client payment option and a first client payment modality and associated with a second device of the set of two or more client devices, in order to facilitate at least a portion of the particular transaction module 502 adapting one or more of a vendor payment option (e.g., online store “points” or “credits” that are purchased for use) and a vendor payment modality (e.g., device authentication via wireless network) for use with a second client payment channel including one or more of a second client payment option (e.g., credit card alpha) and a second client payment modality (e.g., credit card verification with personal identification number) acquired from the second device (e.g., a game controller) of the set of two or more client devices, to facilitate at least a portion of the further transaction (e.g., making an in-game purchase of items that are not used in a game, e.g., a branded t-shirt celebrating an in-game achievement), wherein at least one of the second client payment option (e.g., credit card alpha) and the second client payment modality (e.g., device authentication via wireless network) is different than at least one of a first client payment option (e.g., online store points for a different vendor than one that is providing the in-game experience) and a first client payment modality (e.g., device authentication via fingerprint scan).

Referring again to FIG. 9A, operation 902 may include operation 904 depicting adapting a vendor payment option of credit card delta for use with a second client payment option including credit card alpha acquired for a smartphone device of a particular user, to facilitate at least a portion of a transaction to pay for a food item after sitting down in a seat at a movie theater, wherein the second client payment option including credit card alpha is different than the first client payment option of credit card gamma. For example, FIG. 5, e.g., FIG. 5A, shows vendor payment channel from vendor payment channel set adapting for use with an acquired second client payment channel including at least one of a specific second client payment option and a specific second client payment modality that is different than the first client payment channel including a first client payment option and a first client payment modality and associated with a second device of the set of two or more client devices, in order to facilitate at least a portion of the particular transaction module 504 adapting a vendor payment option of credit card delta for use with a second client payment option including credit card alpha acquired for a smartphone device of a particular user, to facilitate at least a portion of a transaction to pay for a food item after sitting down in a seat at a movie theater, wherein the second client payment option including credit card alpha is different than the first client payment option of credit card gamma.

Referring again to FIG. 9A, operation 902 may include operation 906 depicting adapting a vendor payment modality of credit card swipe-and-signature for use with a second client payment modality of credit card number-alone acquired from a tablet device carried by a user at a coffee shop, to facilitate at least a portion of a transaction of paying for a coffee drink without leaving the table at which the user is seated with the tablet device, wherein the second client payment modality of credit card number-alone is different than the first client payment modality of credit card swipe-and-billing-zip-code. For example, FIG. 5, e.g., FIG. 5A, shows vendor payment channel from vendor payment channel set adapting for use with an acquired second client payment channel including at least one of a specific second client payment option that requires fewer steps to carry out than a vendor payment option of the vendor payment channel and a specific second client payment modality that requires fewer steps to carry out than a vendor payment modality of the vendor payment channel that is different than the first client payment channel including a first client payment option and a first client payment modality and associated with a second device of the set of two or more client devices, in order to facilitate at least a portion of the particular transaction module 506 adapting a vendor payment modality of credit card swipe-and-signature for use with a second client payment modality of credit card number-alone acquired from a tablet device carried by a user at a coffee shop, to facilitate at least a portion of a transaction of paying for a coffee drink without leaving the table at which the user is seated with the tablet device, wherein the second client payment modality of credit card number-alone is different than the first client payment modality of credit card swipe-and-billing-zip-code.

Referring now to FIG. 9B, operation 606 may include operation 908 depicting adapting at least one vendor payment channel of the vendor payment channel set for use with a second client payment channel acquired from a second device of the two or more client devices, said vendor payment channel configured to allow a user of the second device of the set of two or more client to avoid an action for carrying out the further transaction. For example, FIG. 5, e.g., FIG. 5B, shows vendor payment channel that is configured to allow a user of the second device to avoid a particular action from vendor payment channel set adapting for use with an acquired second client payment channel different than the first client payment channel and associated with a second device of the set of two or more client devices, in order to facilitate at least a portion of the particular transaction module 508 (e.g., device tap using near field communication as a vendor payment modality) for use with a second client payment channel (e.g., voice recognition to access user accounts as a client payment option and modality (e.g., a user account as a client payment option and voice recognition to authenticate/verify identity as a client payment modality) acquired from a second device (e.g., a pager with voice recognition capabilities handed to a user as they enter the hardware store) of the two or more client devices (e.g., a set of pagers handed to customers inside of a store), said vendor payment channel configured to allow a user of the second device of the set of two or more client devices to avoid an action (e.g., physically swiping a credit card, or waiting in a line to hand a cashier a form of payment) for carrying out the further transaction (e.g., paying for wares at the hardware store).

Referring again to FIG. 9B, operation 908 may include operation 910 depicting adapting at least one vendor payment channel of the vendor payment channel set for use with a second client payment channel acquired from a second device of the two or more client devices, said vendor payment channel configured to allow a user of the second device of the set of two or more client devices to avoid an action of waiting in line to carry out the further transaction. For example, FIG. 5, e.g., FIG. 5B, shows vendor payment channel that is configured to allow a user of the second device to avoid a waiting in a line action adapting for use with an acquired second client payment channel different than the first client payment channel and associated with a second device of the set of two or more client devices, in order to facilitate at least a portion of the particular transaction module 510 adapting at least one vendor payment channel (e.g. device authentication and credit card retrieval via a secure wireless network) of the vendor payment channel set for use with a second client payment channel (e.g., credit card verification with signature) acquired from a second device (e.g., a user's tablet device) of the two or more client devices to avoid an action of waiting in line to carry out the further transaction.

Referring again to FIG. 9B, operation 908 may include operation 912 depicting adapting at least one vendor payment channel of the vendor payment channel set for use with a second client payment channel acquired from a second device of the two or more client devices, said vendor payment channel configured to allow a user of the second device of the set of two or more client devices to avoid an action of leaving the user's seat to pay for a food concession item. For example, FIG. 5, e.g., FIG. 5B, shows vendor payment channel that is configured to allow a user of the second device to avoid a getting up from a seat action from vendor payment channel set adapting for use with an acquired second client payment channel different than the first client payment channel and associated with a second device of the set of two or more client devices, in order to facilitate at least a portion of the particular transaction module 512 adapting at least one vendor payment channel of the vendor payment channel set for use with a second client payment channel acquired from a second device of the two or more client devices, said vendor payment channel configured to allow a user of the second device of the set of two or more client devices to avoid an action of leaving the user's seat to pay for a food concession item.

Referring again to FIG. 9B, operation 908 may include operation 914 depicting adapting at least one vendor payment channel of the vendor payment channel set for use with a second client payment channel acquired from a second device of the two or more client devices, said vendor payment channel configured to allow a user of the second device of the set of two or more client devices to avoid an action of providing a waiter with a physical instantiation of a payment option. For example, FIG. 5, e.g., FIG. 5B, shows vendor payment channel that is configured to allow a user of the second device to avoid a providing a physical payment object adapting for use with an acquired second client payment channel different than the first client payment channel and associated with a second device of the set of two or more client devices, in order to facilitate at least a portion of the particular transaction module 514 adapting at least one vendor payment channel adapting at least one vendor payment channel (e.g., device tap using near-field communication as a vendor payment modality) of the vendor payment channel set for use with a second client payment channel (e.g., credit card swipe and signature as a client payment modality) acquired from a second device (e.g., a user's smartphone) of the two or more client devices, said vendor payment channel configured to allow a user of the second device of the set of two or more client devices to avoid an action of providing a waiter with a physical instantiation (e.g., a credit card) of a payment option (e.g., the credit card, e.g., using credit card swipe and signature as a payment modality)

Referring now to FIG. 9C, operation 606 may include operation 916 depicting adapting at least one vendor payment channel of the vendor payment channel set for use with a second client payment channel acquired from a second device of the set of two or more client devices, to facilitate at least a portion of the further transaction, wherein the second client payment channel is present in the vendor payment channel set. For example, FIG. 5, e.g., FIG. 5C, shows vendor payment channel from vendor payment channel set adapting for use with an acquired second client payment channel present in the vendor payment channel set and associated with a second device of the set of two or more client devices, in order to facilitate at least a portion of the particular transaction module 516 adapting (e.g., in this case, adapting includes facilitating the transaction without further conversion, because the vendor payment channel and the second client payment channel are the same) at least one vendor payment channel (e.g., frequent shopper rewards card as a vendor payment option) for use with a second client payment channel (e.g., frequent shopper rewards card as a client payment option) acquired from a second device (e.g., a smart shopping cart used by the second client) of the set of two or more client devices, to facilitate at least a portion of the particular transaction (e.g., paying for groceries, wherein the second client payment channel (e.g., frequent shopper rewards card as a vendor payment option) is present in the vendor payment channel set (e.g., the vendor is configured to accept the payment channel used by the second client, e.g., frequent shopper rewards card as a client payment option).

Referring again to FIG. 9C, operation 606 may include operation 918 depicting adapting at least one vendor payment channel of the vendor payment channel set for use with a second client payment channel acquired from a second device of the set of two or more client devices, to facilitate at least a portion of the further transaction, wherein the second client payment channel is absent in the vendor payment channel set. For example, FIG. 5, e.g., FIG. 5C, shows vendor payment channel from vendor payment channel set adapting for use with an acquired second client payment channel that is different than the first client payment channel and also absent from the vendor payment channel set, said second client payment channel associated with a second device of the set of two or more client devices, in order to facilitate at least a portion of the particular transaction module 518 adapting (e.g., in a specific example, verifying the user's identity and obtaining the user's PIN from the credit card company database) at least one vendor payment channel (e.g., credit card beta as a payment option and a credit card verification with swipe only as a payment modality) for use with a second client payment channel (e.g., credit card verification with personal identification number as a client payment modality) acquired from a second device (e.g., a smartphone, e.g., a Samsung Galaxy S) of the set of two or more client devices, to facilitate at least a portion of the further transaction (e.g., paying for movie tickets), wherein the second client payment channel is absent in the vendor payment channel set.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in an embodiment,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

What is claimed is:

1-155. (canceled)

156. A device, comprising:
a request to carry out at least one particular transaction with a set of two or more client devices that have a particular property in common acquiring module;
a vendor payment channel from vendor payment channel set adapting for use with an acquired first user payment channel associated with a first device of the set of two or more client devices in order to facilitate at least a portion of the particular transaction module; and
a vendor payment channel from vendor payment channel set adapting for use with an acquired second client payment channel different than the first client payment channel and associated with a second device of the set of two or more client devices, in order to facilitate at least a portion of a further transaction module.

157. (canceled)

158. (canceled)

159. (canceled)

160. (canceled)

161. (canceled)

162. (canceled)

163. (canceled)

164. (canceled)

165. The device of claim 156, wherein said request to carry out at least one particular transaction with a set of two or more client devices that have a particular property in common acquiring module comprises:
a request to carry out at least one particular transaction with a set of two or more client devices that have a particular device characteristic in common acquiring transaction.

166. (canceled)

167. (canceled)

168. The device of claim 165, wherein said request to carry out at least one particular transaction with a set of two or more client devices that have a particular device characteristic in common acquiring transaction comprises:
a request to carry out at least one particular transaction with a set of two or more client devices that have a particular program loaded in device memory in common acquiring module.

169. (canceled)

170. (canceled)

171. (canceled)

172. The device of claim 156, wherein said request to carry out at least one particular transaction with a set of two or more client devices that have a particular property in common acquiring module comprises:
a request to carry out at least one particular transaction with a first client device of the set of two or more client devices and to carry out at least one further transaction with a second client device of the set of two or more client devices that have a particular property in common acquiring module.

173. (canceled)

174. The device of claim 156, wherein said request to carry out at least one particular transaction with a set of two or more client devices that have a particular property in common acquiring module comprises:
a set of two or more client devices having a particular property of being configured to carry out the particular transaction in common detecting module; and
a request to carry out the at least one the particular transaction with at least two of the detected set of two or more client devices module.

175. The device of claim 174, wherein said set of two or more client devices having a particular property of being configured to carry out the particular transaction in common detecting module comprises:
a set of two or more client devices having the particular property of being configured to carry out the particular transaction in common and that meet a particular criteria detecting module.

176. The device of claim 175, wherein said set of two or more client devices having the particular property of being configured to carry out the particular transaction in common and that meet a particular criteria detecting module comprises:
a set of two or more client devices having the particular property of being configured to carry out the particular transaction in common and that are associated with respective clients having a particular customer profile detecting module.

177. The device of claim 156, wherein said vendor payment channel from vendor payment channel set adapting for use with an acquired first user payment channel associated with a first device of the set of two or more client devices in order to facilitate at least a portion of the particular transaction module comprises:
a vendor payment channel from vendor payment channel set interfacing with an acquired first user payment channel associated with a first device of the set of two or more client devices in order to facilitate at least a portion of the particular transaction module.

178. The device of claim 177. wherein said vendor payment channel from vendor payment channel set interfacing with an acquired first user payment channel associated with a first device of the set of two or more client devices in order to facilitate at least a portion of the particular transaction module comprises:
a one or more actions that allow use of the first user payment channel for a first portion of the particular transaction and use of the vendor payment channel for a second portion of the particular transaction executing module.

179. The device of claim 178, wherein said one or more actions that allow use of the first user payment channel for a first portion of the particular transaction and use of the vendor payment channel for a second portion of the particular transaction executing module comprises:
a use of the first client payment channel for the first portion of the particular transaction data receiving module; and
a received data adapting for use with the vendor payment channel as the second portion of the particular transaction module.

180. The device of claim 177. wherein said vendor payment channel from vendor payment channel set interfacing with an acquired first user payment channel associated with a first device of the set of two or more client devices in order to facilitate at least a portion of the particular transaction module comprises:
a portion of the particular transaction using the first device executing using the first client payment channel module; and
a result of executing the portion of the particular transaction using the first device converting for use with the vendor payment channel module.

181. (canceled)

182. The device of claim 156, wherein said vendor payment channel from vendor payment channel set adapting for use with an acquired first user payment channel associated with a first device of the set of two or more client devices in order to facilitate at least a portion of the particular transaction module comprises:
a resource configured to be used to allow the vendor payment channel to be used with the first client payment channel obtaining module; and
a first client payment channel associated with the first device accepting using the obtained resource module.

183. (canceled)

184. (canceled)

185. The device of claim 182, wherein said resource configured to be used to allow the vendor payment channel to be used with the first client payment channel obtaining module comprises:
an arbitraging resource configured to be used to allow the vendor payment channel to be used with the first client payment channel obtaining module.

186. The device of claim 185, wherein said arbitraging resource configured to be used to allow the vendor payment channel to be used with the first client payment channel obtaining module comprises:
an arbitraging resource configured to be used to allow the vendor payment channel to be used with the first client payment channel by accepting payment using the first client payment channel and submitting payment using the vendor payment channel obtaining module.

187. The device of claim 156, wherein said vendor payment channel from vendor payment channel set adapting for use with an acquired first user payment channel associated with a first device of the set of two or more client devices in order to facilitate at least a portion of the particular transaction module comprises:
an external device resource configured to be used to facilitate at least a portion of the particular transaction with the first device information obtaining module; and
a data regarding the obtained information regarding the external device resource to the first device configured to use the first client payment channel transmitting module.

188. The device of claim 187, wherein said external device resource configured to be used to facilitate at least a portion of the particular transaction with the first device information obtaining module comprises:
an external device resource configured to be used to facilitate at least a portion of the particular transaction with the first device by using the first client payment channel and to facilitate another portion of the particular transaction using the vendor payment channel information obtaining module.

189. The device of claim 188, wherein said external device resource configured to be used to facilitate at least a portion of the particular transaction with the first device by using the first client payment channel and to facilitate another portion of the particular transaction using the vendor payment channel information obtaining module comprises:
an external device resource configured to use the first client payment channel and configured to use the vendor payment channel information obtaining module.

190. (canceled)

191. (canceled)

192. (canceled)

193. The device of claim 189, wherein said external device resource configured to use the first client payment channel and configured to use the vendor payment channel information obtaining module comprises:
an external device resource configured to use the first client payment channel and configured to use the vendor payment channel selecting from a generated list of external device resources module.

194. The device of claim 187, wherein said external device resource configured to be used to facilitate at least a portion of the particular transaction with the first device information obtaining module comprises:
an external device resource configured to be used to facilitate at least a portion of the particular transaction with the first device information obtaining by polling at least one device module.

195. (canceled)

196. The device of claim 194, wherein said external device resource configured to be used to facilitate at least a portion of the particular transaction with the first device information obtaining by polling at least one device module comprises:
an external device resource configured to be used to facilitate at least a portion of the particular transaction with the first device information obtaining by polling at least one device having a particular property module.

197. The device of claim 196, wherein said external device resource configured to be used to facilitate at least a portion of the particular transaction with the first device information obtaining by polling at least one device having a particular property module comprises:
an external device resource configured to be used to facilitate at least a portion of the particular transaction with the first device information obtaining by polling at least one device at a particular location module.

198. (canceled)

199. The device of claim 196, wherein said external device resource configured to be used to facilitate at least a portion of the particular transaction with the first device information obtaining by polling at least one device having a particular property module comprises:
an external device resource configured to be used to facilitate at least a portion of the particular transaction with the first device information obtaining by polling at least one device communicating via a particular communication network module.

200. (canceled)

201. The device of claim 196, wherein said external device resource configured to be used to facilitate at least a portion of the particular transaction with the first device information obtaining by polling at least one device having a particular property module comprises:
an external device resource configured to be used to facilitate at least a portion of the particular transaction with the first device information obtaining by polling at least one device that is configured to execute a particular application module.

202. (canceled)

203. (canceled)

204. The device of claim 156, wherein said vendor payment channel from vendor payment channel set adapting for use with an acquired first user payment channel associated with a first device of the set of two or more client devices in order to facilitate at least a portion of the particular transaction module comprises:
a resource configured to be used to link the vendor payment channel with the first client payment channel obtaining module; and
an assistance from the determined resource in facilitating the particular transaction requesting module.

205. The device of claim 204, wherein said resource configured to be used to link the vendor payment channel with the first client payment channel obtaining module comprises:
a resource configured to be used to link the vendor payment channel with the first client payment channel obtaining at least partly based on the first client payment channel module.

206. (canceled)

207. (canceled)

208. (canceled)

209. The device of claim 156, wherein said vendor payment channel from vendor payment channel set adapting for use with an acquired first user payment channel associated with a first device of the set of two or more client devices in order to facilitate at least a portion of the particular transaction module comprises:
an intermediary device having a particular property and configured to facilitate at least a portion of the particular transaction selecting module;
an agreement to facilitate at least a portion of the particular transaction negotiating with the intermediary device module; and
an intermediary device-related data transmitting to the first device module.

210. The device of claim 209, wherein said intermediary device having a particular property and configured to facilitate at least a portion of the particular transaction selecting module comprises:
a second device as intermediary device selecting module.

211. The device of claim 209, wherein said intermediary device having a particular property and configured to facilitate at least a portion of the particular transaction selecting module comprises:
an intermediary device having a particular property and configured to facilitate at least a portion of the particular transaction selecting from the set of two or more client devices module.

212. The device of claim 209, wherein said intermediary device having a particular property and configured to facilitate at least a portion of the particular transaction selecting module comprises:
an intermediary device configured to conduct one or more transactions using the first client payment channel and configured to conduct one or more transactions using the vendor payment channel selecting module.

213. The device of claim 209, wherein said intermediary device having a particular property and configured to facilitate at least a portion of the particular transaction selecting module comprises:
an intermediary device configured to execute a particular program and configured to facilitate at least a portion of the particular transaction selecting module.

214. (canceled)

215. (canceled)

216. The device of claim 209, wherein said intermediary device-related data transmitting to the first device module comprises:
an intermediary device recognition code data transmitting to the first device module.

217. The device of claim 156, wherein said vendor payment channel from vendor payment channel set adapting for use with an acquired first user payment channel associated with a first device of the set of two or more client devices in order to facilitate at least a portion of the particular transaction module comprises:
a transaction using vendor payment channel from vendor payment channel set facilitating at least a portion of the particular transaction such that the first client device is allowed to appear to use the first client payment channel module.

218. (canceled)

219. The device of claim 217, wherein said transaction using vendor payment channel from vendor payment channel set facilitating at least a portion of the particular transaction such that the first client device is allowed to appear to use the first client payment channel module comprises:
an instruction for first device to obtain transaction data at least partly using the first client payment channel providing module;
an instruction for first device to manipulate the transaction data into a format configured to be used with the vendor payment channel providing module; and
an instruction for facilitating the particular transaction using the vendor payment channel providing module.

220. The device of claim 219, wherein said instruction for first device to obtain transaction data at least partly using the first client payment channel providing module comprises:
an instruction for first device to obtain transaction data in order to appear to a user of the first client device that the first client payment channel is used providing module.

221. The device of claim 219, wherein said instruction for first device to manipulate the transaction data into a format configured to be used with the vendor payment channel providing module comprises:
a one or more resources configured to assist in manipulation of the transaction data into a format configured to be used with the vendor payment channel providing module.

222. (canceled)

223. The device of claim 156, wherein said vendor payment channel from vendor payment channel set adapting for use with an acquired second client payment channel different than the first client payment channel and associated with a second device of the set of two or more client devices, in order to facilitate at least a portion of a further transaction module comprises:
a vendor payment channel from vendor payment channel set adapting for use with an acquired second client payment channel including at least one of a second client payment option and a second client payment modality that is different than the first client payment channel including a first client payment option and a first client payment modality and associated with a second device of the set of two or more client devices, in order to facilitate at least a portion of the further transaction module.

224. (canceled)

225. (canceled)

226. The device of claim 156, wherein said vendor payment channel from vendor payment channel set adapting for use with an acquired second client payment channel different than the first client payment channel and associated with a second device of the set of two or more client devices, in order to facilitate at least a portion of a further transaction module comprises:
a vendor payment channel that is configured to allow a user of the second device to avoid a particular action from vendor payment channel set adapting for use with an acquired second client payment channel different than the first client payment channel and associated with a second device of the set of two or more client devices, in order to facilitate at least a portion of the further transaction module.

227. (canceled)

228. (canceled)

229. The device of claim 226, wherein said vendor payment channel that is configured to allow a user of the second device to avoid a particular action from vendor payment channel set adapting for use with an acquired second client payment channel different than the first client payment channel and associated with a second device of the set of two or more client devices, in order to facilitate at least a portion of the further transaction module comprises:
a vendor payment channel that is configured to allow a user of the second device to avoid a providing a physical payment object adapting for use with an acquired second client payment channel different than the first client payment channel and associated with a second device of the set of two or more client devices, in order to facilitate at least a portion of the further transaction module.

230-235. (canceled)
